(19) United States
(12) Patent Application Publication
(10) Pub. No.: US 2018/0266390 A1
(43) Pub. Date: Sep. 20, 2018

(54) WIND POWER GENERATING ROTOR WITH DIFFUSER OR DIVERTER SYSTEM FOR A WIND TURBINE

(71) Applicant: Hover Energy, LLC, Carrollton, TX (US)

(72) Inventors: Carsten Hein Westergaard, Houston, TX (US); Søren Hjort, Silkeborg (DK)

(21) Appl. No.: 15/934,510

(22) Filed: Mar. 23, 2018

Related U.S. Application Data
(63) Continuation-in-part of application No. 14/210,370, filed on Mar. 13, 2014, now abandoned.
(60) Provisional application No. 62/475,344, filed on Mar. 23, 2017.
(60) Provisional application No. 61/785,776, filed on Mar. 14, 2013.

(51) Int. Cl. F03D 3/04; F03D 3/00

(52) U.S. Cl. CPC F03D 3/0454; F03D 3/002; F03D 3/0409; F03D 3/005; F05B 2240/121; F05B 2240/2212; F05B 2250/71; F05B 2240/13

(57) ABSTRACT

A wind power generating rotor system for a wind turbine. The rotor system includes a rotor assembly having a rotor axis and a plurality of rotor blades structured and arranged for rotation around the rotor axis by wind passing the rotor blades thereby capturing kinetic energy from the wind. A diverter assembly is provided having a plurality of diverters structured and arranged at one or both of inside and outside a perimeter defined by rotation of the rotor blades thereby increasing the power of the rotor system.

### CROSS-REFERENCE TO EARLIER APPLICATIONS

This application claims priority under 35 U.S.C. § 119(e) to U.S. Provisional Patent Application Ser. No. 62/475,344, filed Mar. 23, 2017, and is a Continuation in Part of U.S. patent application Ser. No. 14/210,370, filed Mar. 13, 2014, which claims priority to U.S. Provisional Patent Application No. 61/785,776, filed Mar. 14, 2013, the entire contents of each of which are incorporated herein by reference.

### FIELD OF THE INVENTION

The present invention relates to wind power generating rotor systems for wind turbines having improved performance in capturing kinetic energy of the wind. In particular, the present invention relates to rotor systems having diverter assemblies that maximize an expansion ratio between the rotor area and the exit area of the rotor system thereby increasing the power of the rotor systems.

### BACKGROUND

The use of wind power for electrical power generation depends on the efficient capture and harnessing of the kinetic energy of the wind by rotor assemblies that are used for wind turbine systems. For example, some wind turbines have rotor assemblies with a rotor axis that is horizontally oriented (HAWT) and rotor blades that rotate around the axis when wind passes the rotor blades. The kinetic wind energy captured by the rotor assembly is used for generating electrical energy, among other possible uses. Similarly, rotor assemblies with vertically oriented rotor axes (VAWT) also may be used to capture the kinetic energy of the wind in a manner similar in concept to the horizontally oriented rotor assemblies.

VAWTs are commonly used in the market for small wind turbines. Their benefit compared to the market-dominating HAWTs is that no rotor axis alignment with the wind direction is necessary, since the vertical axis rotor assembly captures the wind energy equally well from all sides. A VAWT rotor can spin fast with a high ratio between the rotor tip circumferential velocity and the free wind velocity, the so-called Tip-Speed Ratio (TSR). In the case of a high TSR (2, 3, or higher), the interaction forces between the passing air and the rotor blades will be dominated by lift forces, i.e., aerodynamic forces perpendicular to the local velocity of the air passing the rotor blades. In the case of a low TSR (2 or lower), the interaction forces between the passing air and the rotor blades will be dominated by drag forces, i.e., aerodynamic forces parallel to the local velocity of the air passing the rotor blades. The lift-force dominated high TSR VAWT rotor assembly will have a high power efficiency, since lift-forces are nearly loss-free, but can be noisy due to the high circumferential velocity of the fast spinning rotor blades. Contrarily, a drag-force dominated low TSR VAWT rotor assembly will have lower efficiency, since drag-forces are associated with viscous diffusivity losses, but will be silent due to the low circumferential velocity of the rotor blades. In general, VAWTs rotate slower than HAWTs and are often less noisy.

HAWTs are commonly used in the market for wind turbines of all sizes. Their benefit is high efficiency and conceptual simplicity. A HAWT rotor spins fast with a high ratio between the rotor tip circumferential velocity and the free wind velocity, i.e., a high TSR. HAWTs operate efficiently at high TSR, typically 6 and above.

The lift-force dominated high TSR HAWT rotor assembly will have a high power efficiency, since lift-forces are nearly loss-free, but will be noisy due to the high circumferential velocity of the fast spinning rotor blades. Contrarily, a drag-force dominated low TSR wind turbine rotor assembly will have lower efficiency, since drag-forces are associated with viscous diffusivity losses, but will be silent due to the low circumferential velocity of the rotor blades. Such a low TSR rotor is characterized by the way in which the wind drags the rotor around its axis, similarly to the aerodynamic principle of the well-known cup anemometers. The axis orientation of such a low TSR drag-dominated wind turbine rotor will be perpendicular to the wind, instead of aligned to it, and can be either vertical or horizontal.

The Vertical-Axis low TSR Wind Turbine (a low TSR VAWT) is most common, since it operates independently of the wind direction and therefore does not need any kind of yaw system to orient the rotor towards the wind. FIGS. 1 and 2 are illustrations of such low TSR VAWTs, FIG. 2 being a cross section of such a VAWT. By contrast, the perpendicularly oriented horizontal-axis low TSR wind turbine is uncommon, since under normal conditions it offers no advantage over the before-mentioned vertical-axis low TSR configuration.

Low TSR wind turbine systems are attractive for the household wind turbine market, since they only have slowly rotating parts, and therefore induce almost no noise and/or vibrations. Household wind turbines can be mounted either in close vicinity to a building or on the rooftop of the building itself.

For rooftop-mounted wind turbines, including vertical-axis low TSR turbines, it is a disadvantage that the flow over the rooftop is vertically sheared. It induces fluctuating loads and the aerodynamic principle of the rotor system would be better off with a uniform wind inflow.

For rooftop-mounted wind turbines, including vertical-axis low TSR turbines, it is also a disadvantage that efficient “harvest” of the energy contained in the wind passing the rooftop cannot be done by only one wind turbine, but would require a plurality of wind turbines spanning the leading edge (or edges) of the rooftop.

Improving the performance of rotor assemblies for wind turbines is vital for the efficient capture and harnessing of wind energy in wind turbine systems for electrical power generation, among other known uses of such systems. As such, there is a need for wind power generating rotor systems having improved performance in capturing kinetic energy of the wind, in particular, for increasing the power of the rotor systems.

### SUMMARY

The present invention relates to wind power generating rotor systems for wind turbines having improved performance in capturing kinetic energy of the wind. In particular, the present invention relates to rotor systems having diverter assemblies that increase the kinetic energy that the wind turbine is able to extract from wind. This may be, for example, by maximizing an expansion ratio between the rotor area and the exit area of the rotor system thereby increasing the power of the rotor systems.

In certain aspects of the present disclosure, the wind power generating rotor systems for wind turbines include a rotor assembly with rotor blades and a diverter assembly having one or multiple main, or primary diverters, or one or multiple minor, or secondary diverters, as well as additional diverters, such as flap diverters or slot diverters. The diverter assembly may further comprise one or multiple inner diverters. The diverter assemblies of the present disclosure may include diverters with aerodynamic surfaces, such as in airfoil shapes and generally flat or curved plate shapes. The diverter assemblies of the present disclosure may be arranged in symmetrical or asymmetrical configurations.

In certain configurations of a diverter assembly disclosed herein, such as asymmetric configurations, a main or primary diverter may be an airfoil having an angle of attack relative to air flow that directs airflow towards the center of the rotor assembly. In such an asymmetric configuration, a minor or secondary diverter of the diverter assembly may be located opposite the rotor assembly. For asymmetric configurations, the diverters will not have the same body shape or configuration as each other. Typically, the diverters that comprise the diverter assembly extend tangentially to a perimeter of a rotation path of the rotor blades, and have a two dimensional profile extending parallel to the rotation path.

In other embodiments disclosed herein, the diverter assemblies may include one or more flap diverter configured to function with the primary diverter as a flapped airfoil, with one or multiple flaps. Further, one or more diverter of the diverter assemblies herein may be configured as a slot diverter to function as a slot at a leading edge of a primary airfoil. Additionally, one or more diverter of the diverter assemblies herein may be configured as a multi-wing stacked arrangement, such as a bi-plane, triple-decker, or more.

The present disclosure does not discuss the structure and configurations of the rotor blades in detail since such are generally known to persons skilled in the art.

The inventors have found that when low TSR rotor systems for wind turbines, as disclosed herein, are provided with asymmetric diverter assemblies in certain configurations, the power efficiency of the rotor system is significantly increased.

The present disclosure provides wind power generating rotor systems for wind turbines. The rotor systems typically include a rotor assembly having a rotor axis and a plurality of rotor blades structured and arranged for rotation around the rotor axis by wind passing the rotor blades thereby capturing kinetic energy from the wind. A diverter assembly is provided having a plurality of diverters arranged at one or both of inside and outside a perimeter defined by rotation of the rotor blades thereby increasing the power of the rotor system.

In certain embodiments of the present disclosure, the plurality of diverters of the diverter assembly, occasionally referred to herein as a diffuser assembly, are structured and arranged such that an expansion ratio of the rotor system is increased. The expansion ratio is the ratio Aₑₓᵢₜ/Aᵣₒₜₒᵣ between a rotor area Aᵣₒₜₒᵣ and an exit area Aₑₓᵢₜ of the rotor system. In other embodiments herein, the diverter assembly includes plate diverters located at respective opposing end portions of the rotor axis. Such plate diverters may be perpendicular to the primary and secondary diverters, and may be parallel to the rotation path of the rotor blades, rather than tangential thereto.

The rotor axis may be vertically oriented or horizontally oriented, and, in certain aspects, the horizontally oriented rotor axis is perpendicular to a direction of the wind.

In certain aspects of the present disclosure, the plurality of diverters may be located outside the perimeter of the rotor blades and may be configured and arranged in a symmetrical configuration with each diverter having two or more flaps. In other aspects, at least one of the plurality of diverters may be located inside the perimeter of the rotor blades and, in yet other aspects, the plurality of diverters may be located inside and outside the perimeter of the rotor blades. For example, at least two diverters of the plurality of diverters may be located outside the perimeter of the rotor blades and configured and arranged in an asymmetric configuration with each diverter located outside the perimeter being associated with two or more flap diverters, and at least one diverter of the plurality of diverters may be located inside the perimeter.

In other embodiments disclosed herein, the diverter assembly may include at least one diverter on a first outer side of the rotation path of the rotor blades and at least one second diverter on a second outer side of the rotation path of the rotor blades, opposite the first diverter with the first diverter and the second diverter having an asymmetric configuration. Further, the diverter assembly may include at least two diverters located outside the perimeter of the rotation path on opposite sides of the perimeter with the at least two diverters having a symmetrical configuration.

Each of the diverters of the diverter assembly may have a flat plate shape or a generally curved plate shape or an airfoil shape comprising a leading edge and a trailing edge with a camber shaped surface there between. The diverters may further be provided with a more complex two dimensional profile, as discussed in more detail below. A primary diverter having an airfoil shape may have at least one flap diverter associated with, or attached to, the trailing edge of the airfoil shaped diverter or a plurality of flap diverters with each flap diverter itself having an airfoil shape. In such an embodiment, typically, a first flap diverter might be attached to the trailing edge of the primary airfoil shaped diverter with a first slot between the primary diverter and the first flap diverter, and a second flap diverter may be attached to the trailing edge of the first flap diverter with a second slot therebetween.

In certain aspects of the present disclosure, a slot may be provided between a diverter having an airfoil shape and an associated flap and, in other aspects, the diverter assembly may include at least one diverter having at least two generally flat wing shaped elements in a stacked configuration to form the diverter.

The plurality of rotor blades of the rotor system may be structured and arranged in a lift based configuration in which the rotor blades are substantially tangential to the perimeter of the rotation path, or in a drag based configuration in which the rotor blades are substantially perpendicular to the perimeter of the rotation path, or in one or more intermediate configuration between lift and drag based configurations. In some embodiments, the rotor blades may be convertible between lift and drag based configurations.

In certain aspects disclosed herein, a predetermined gap may be provided between the perimeter defined by rotation of the rotor blades and a diverter located outside the perimeter. The predetermined gap may be from 3.5% to 25% of the diameter of the perimeter defined by rotation of the rotor blades, for example, about 15% of the diameter of the perimeter defined by rotation of the rotor blades. The predetermined gap being structured and arranged for bypass flow of wind passing the rotor blades thereby stabilizing wind flow.

### BRIEF DESCRIPTION OF THE DRAWINGS

FIG. 1 illustrates a low TSR VAWT as seen in perspective;

FIG. 2 is a cross section view of a rotor assembly of a low TSR VAWT with the wind direction shown by arrow A;

FIGS. 3A-D illustrate different rotor blade pitch angles on a clock wise rotating rotor assembly;

FIG. 4 is a graph showing lift forces on a rotor for various blade positions corresponding to the configuration shown in FIG. 3D, with the 90 degree rotor position corresponding to a blade facing the wind;

FIG. 5 is a graph showing drag forces on a rotor for various blade positions corresponding to the configuration shown in FIG. 3D;

FIG. 6 is a graph showing tangential forces on a rotor for various blade positions corresponding to the configuration shown in FIG. 3D and based on the data shown in FIGS. 4 and 5 and rotor configuration, with the dark line corresponding to TSR 0.9 corresponding to optimal performance;

FIG. 7 is a graph showing lift forces on a rotor corresponding to the configuration shown in FIG. 3A, wherein with the thick black line, TSR 2.5, corresponds to optimal performance;

FIG. 8 is a graph showing drag forces on a rotor corresponding to the configuration shown in FIG. 3a, wherein the thick black line, TSR 2.5, corresponds to optimal performance;

FIG. 9 is a graph showing tangential forces on a rotor corresponding to the configuration shown in FIG. 3A, wherein the thick black line, TSR 2.5, corresponds to optimal performance;

FIG. 10 depicts one embodiment of a wind power generating rotor system according to the present disclosure showing both a rotor assembly and a diverter assembly;

FIG. 11 illustrates a cross section of one possible rotor system having a drag-based configuration with an asymmetric diverter assembly and showing incoming wind at an angle with respect to the main diverter;

FIG. 12 shows one possible airfoil shape according to the present disclosure;

FIG. 13 illustrates a slotted asymmetric diverter assembly with a VAWT as seen from behind in perspective;

FIG. 14 illustrates a cross section of a slotted asymmetric diverter VAWT with a double slotted high-lift diverter configuration and a low-lift diverter;

FIG. 15 illustrates a cross section of a slotted asymmetric diverter VAWT similar to FIG. 14, but with airfoil rotor blades instead of the curved plate rotor blades in FIG. 14;

FIG. 16 is a cross sectional representation of a lift based rotor assembly having one possible diverter assembly according to the present disclosure;

FIG. 17 illustrates a cross section of a VAWT having a slotted asymmetric diverter assembly with a single slotted high-lift diverter configuration and a low-lift diverter airfoil;

FIG. 18 illustrates a cross section of a slotted asymmetric diverter assembly VAWT with a double slotted high-lift diverter configuration and a single slotted low-lift diverter configuration;

FIG. 19 illustrates a cross section of a slotted asymmetric diverter assembly VAWT as in FIG. 18, but with airfoil-shaped low-lift diverters;

FIG. 20 illustrates a cross section of a slotted asymmetric diverter assembly VAWT with a double slotted high-lift diverter configuration and a low-lift diverter with streamline visualization, and without the rotor assembly shown;

FIG. 21 illustrates a VAWT with a single airfoil-shaped internal diverter as seen in perspective;

FIG. 22 illustrates a cross section of a VAWT with a single curved plate internal diverter;

FIG. 23 illustrates a cross section of a VAWT with airfoil-shaped rotor blades, and with a single curved plate internal diverter;

FIG. 24 illustrates a cross section of a VAWT similar to FIG. 23 with differently sized and numbered airfoil-shaped rotor blades, and with a single curved plate internal diverter;

FIG. 25 illustrates a cross section of a VAWT with a single airfoil-shaped internal diverter;

FIG. 26 illustrates a cross section of a VAWT with a pair of curved plate internal diverters;

FIG. 27 illustrates a cross section of a VAWT with multiple curved plate internal diverters;

FIG. 28 illustrates a cross section of a VAWT with multiple curved plate internal diverters and an external diverter assembly having a high-lift diverter and a low-lift diverter;

FIG. 29 illustrates a cross section of a VAWT with multiple curved plate internal diverters and an external diverter assembly, with internal streamline flow visualization (rotor omitted for visualization clarity);

FIG. 30 illustrates another possible embodiment of the present disclosure in which a drag-based rotor is shielded by a double slotted high-lift diverter configuration of a slotted asymmetric diverter assembly also having an external low-lift diverter airfoil and multiple curved plate internal diverters;

FIG. 31 illustrates another possible embodiment of the present disclosure in which a lift-based rotor is shielded by a double slotted high-lift diverter configuration of a slotted asymmetric diverter assembly also having an external low-lift diverter and multiple curved plate internal diverters;

FIGS. 32-46 illustrate other possible embodiments of the present disclosure in which various possible diverter assemblies according to the present disclosure are depicted with a circle representing the outer perimeter defined by rotation of the rotor blades (not shown);

FIG. 47 shows a gap between the outer perimeter defined by rotation of the rotor blades (in this embodiment drag-based rotor blades) and the opposing outer surfaces of external diverters for a slotted asymmetric diverter assembly VAWT;

FIG. 48 illustrates air flow entering a gap between the outer perimeter defined by rotation of the rotor blades (in this embodiment drag-based rotor blades) and the opposing outer surfaces of external diverters for an asymmetric diverter assembly VAWT (the solid line circles indicate the inner and outer perimeters of the rotor blades as the rotor blades rotate around the vertical axis of the rotor assembly);

FIG. 49 shows a gap between the outer perimeter defined by rotation of the rotor blades and the opposing outer surfaces of external diverters for a slotted symmetric diverter assembly VAWT;

FIG. 50 is a graph showing the idealized potential flow velocity and power losses from the gap introduction as a function of the diverter location (the gap size is the diverter location minus 1 in this graph);

FIG. 51 illustrates the overall system efficiency (shown as the relative power coefficient) as a function of the gap size (the gap size is normalized to the rotor diameter) based on system modeling of which results of FIG. 50 is a subset of illustrations to the effects;

FIG. 52 illustrates a computation result of a wind power generating rotor system according to the present disclosure without a gap;

FIG. 53 illustrates a computation result of a wind power generating rotor system according to the present disclosure with a gap;

FIG. 54 depicts another embodiment of a wind power generating rotor system according to the present disclosure;

FIG. 55 depicts yet another embodiment of a wind power generating rotor system according to the present disclosure;

FIG. 56 illustrates a cross section of a low TSR perpendicular-axis HAWT on a rooftop;

FIG. 57 illustrates a low TSR perpendicular-axis HAWT on a rooftop as seen in perspective;

FIG. 58 illustrates a cross section of an asymmetric diverter assembly perpendicular-axis HAWT having internal diverters on a rooftop;

FIG. 59 illustrates a cross section of an asymmetric diverter assembly perpendicular-axis HAWT with airfoil-shaped rotor blades and with a different number of rotor blades and internal diverters, than the embodiment depicted in FIG. 58, on a rooftop;

FIG. 60 illustrates a cross section of an asymmetric diverter assembly perpendicular-axis HAWT with a differently configured diverter assembly, than the embodiments depicted in FIGS. 58 and 59, on a roof-top;

FIG. 61 illustrates an asymmetric diverter assembly perpendicular-axis HAWT on a rooftop as seen in perspective.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

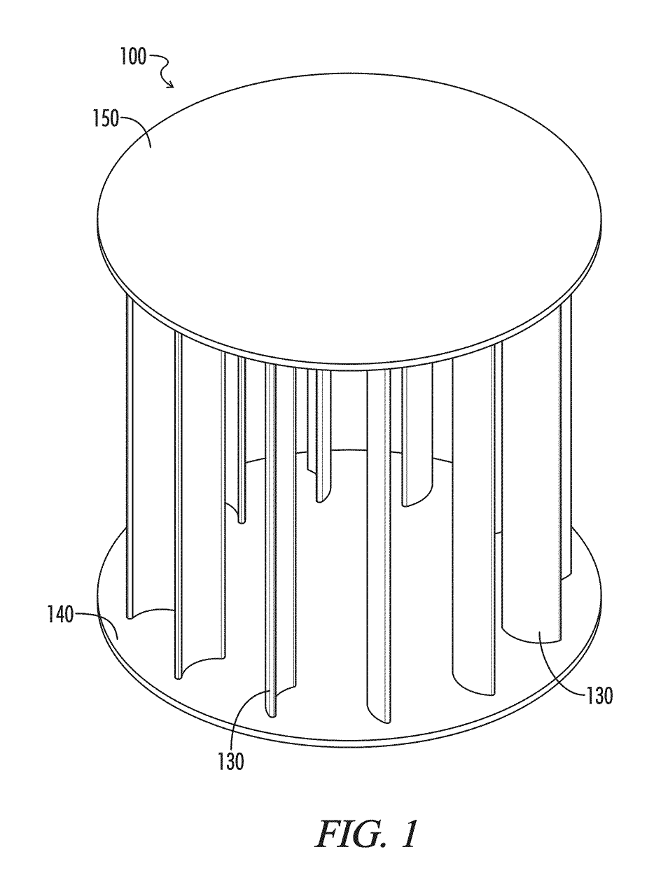

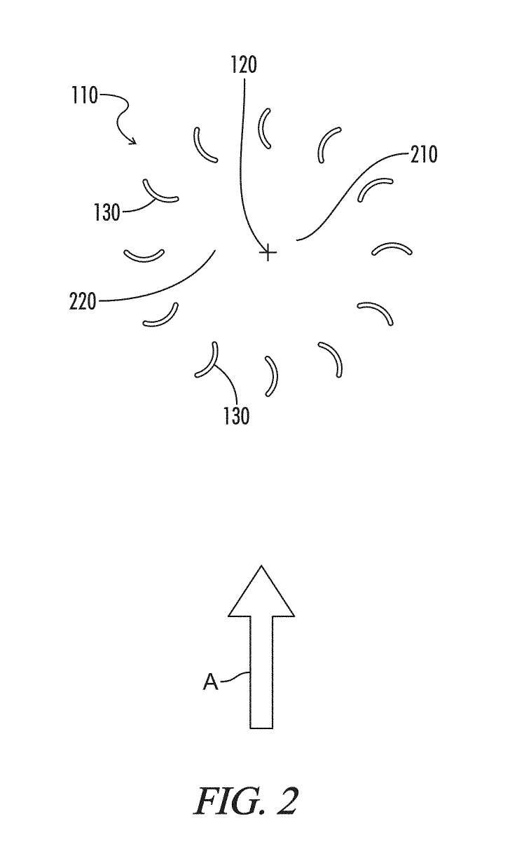

FIG. 1 illustrates an exemplary low TSR VAWT 100, of the type previously discussed above, and FIG. 2 shows, in cross section, a rotor assembly 110 of the VAWT that rotates around rotor axis 120. In FIG. 1, curved plate rotor blades 130 are shown arranged between a bottom endplate 140 and a top endplate 150. FIG. 2 indicates the work stroke flow zone 210 and the return stroke flow zone 220 of the vertical rotor assembly 110 for the free wind direction indicated by the arrow A.

The present disclosure provides a description of significant research efforts by the present inventors in investigating different configurations of diffuser and diverter assemblies (disclosed hereinafter) and of the various diverters that are included in the assemblies. As an initial aspect of the investigation, it is noted that for a shrouded rotor, C_{p,rotor} generally cannot exceed both Betz limits, where rotor C_{p,rotor} is the non-dimensional kinetic energy extracted from the wind potential represented by the rotor area. The relationship is illustrated below:

$$\begin{matrix}P = 0.5 \cdot ρ \cdot {C}_{p , rotor} \cdot {A}_{rotor} \cdot {U}^{3} \\ = 0.5 \cdot ρ \cdot {C}_{p , exit} \cdot {A}_{exit} \cdot {U}^{3} \\ = 0.5 \cdot ρ \cdot {C}_{p , exit} \cdot \frac{{A}_{exit}}{{A}_{rotor}} \cdot {A}_{rotor} \cdot {U}^{3}\end{matrix}$$

For a shrouded rotor, the ratio between the rotor area Aₘₒₜₒᵣ, i.e., the area of the circle defined by rotation of the rotor blades around the axis of the rotor, and the exit area Aₑₓᵢₜ, i.e., the area through which wind exiting the rotor area passes, is called the expansion ratio. It has been shown that the above statements concerning Betz hold accurate, and the rotor based Cₚ is dependent on the expansion ratio. It is understood that height of the rotor and the exit area is implied when one references this as an area, and is left out of the description for convenience.

An example for rotor systems found in Widnall (2009) shows the rotor curve Cₚ versus tip speed ratio (TSR) is identical to the shrouded rotor if C_{p,exit} if based on the exit area. The inventors realized that the above is only true in theory and for practical applications there will be some differences because of fluid losses or gains and complications such as stall on one or multiple surfaces. However, the principle applies within reason rather broadly to the concept of expansion, regardless of the rotor type and expansion type. In Watanabe (2016), two-bladed and three-bladed vertical axis wind turbines with various rotor airfoils are tested in a number of different expansion ratios in a wind tunnel. The present inventors detailed analysis of the data, beyond the paper's own scope, led them to the realization that:

C_{p,D}(λ_{D})˜α·C_{p,rotor}(λ_{∞})

where

λ_{D}˜β·λ_{∞}.

where λ_{∞} is the tip speed ratio (ratio of rotor blade speed over wind velocity) in relation to the free wind speed for a rotor without a diffusor and λ_{D} is the tip speed of the same rotor in the shrouded (expanded rotor) based on the free wind velocity. α and β is are constants. The present inventors discovered that for all of the different expansion ratios and rotors investigated in Watanabe, C_{p,exit} is almost constant at approximately 0.33.

Geurts et. al. (2010) provides computation of a rotor between two airfoils, for a configuration very similar to Watanabe. Here, details of the forces acting on the individual surfaces are illustrated. The forces on the rotor blades for the shrouded versus the free rotor exhibit similarities and, when aggregated, results in the proportional relationship between a free and shrouded rotor as discussed above.

Barannyka et. al. (2013) provides a water tunnel investigation of a Savonius (or drag-based) style rotor between two airfoils. This system had an expansion ratio of 3.05, while only a C_{p,rotor} increase of a factor of 1.35. Therefore, the shrouded rotor showed a decreased performance of the rotor if observing C_{p,exit}. The present inventors recognized that it would have been more beneficial and simpler to make the rotor bigger in order to get to more power. Nevertheless, the shape Cp-λ, of the free rotor and the shrouded rotor were very similar.

Shahizare (2016) analyzes an omni-directional turbine for different expansion ratios of a five-bladed lift-based rotor in a wind tunnel. Although not the same type of diffusor or diverter assembly as those described, those turbine curves are almost identical for the expansion ratios investigated in the paper, from 1.4 to 3.4. The rotor based C_{p,rotor} peaks for an expansion ratio of about 1.8 at value of 0.40, but the exit based C_{p,exit} is actually only about 0.22 where the free rotor Cₚ is 0.30. Again, the inventors recognized that this particular concept has a strong down side to the configuration and a bigger rotor would have been better, if its development focused on the performance.

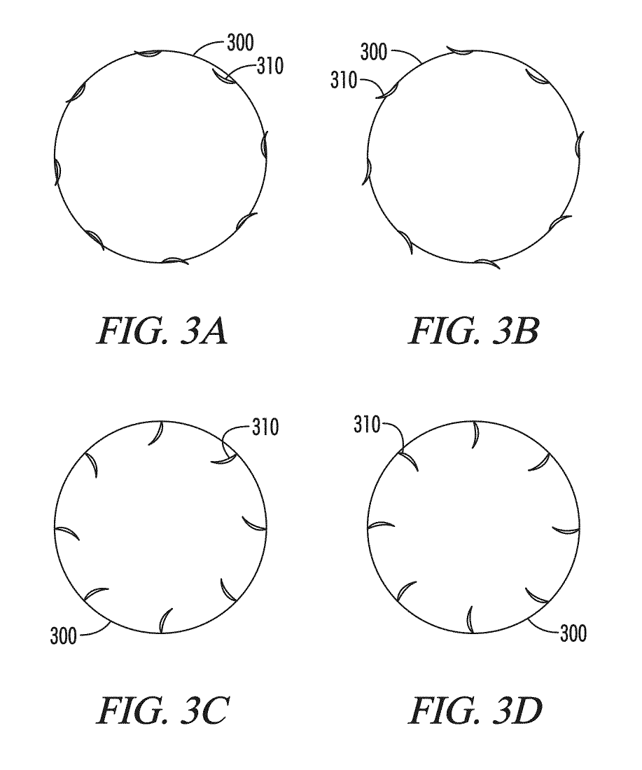

FIGS. 3A-D illustrate different rotor blade pitch angles on a clock wise rotating rotor 300. The circle indicates the rotor plane definition. In FIG. 3A, the configuration of the rotor blades 310 is normally called a “lift-based rotor” and the configuration in FIG. 3D is normally considered a “drag-based rotor”. This is however somewhat misleading, as discussed in further detail below.

In FIG. 3A, a rotor blade 310 pressure side faces the wind in such way that the blade chord (defined by a line from the nose of the airfoil blade to the sharp trailing edge of the airfoil blade (note also FIG. 12)) is 0 degrees off from the tangent to the circle. In FIG. 3B, the blade is 10 degrees away from the wind, i.e., plus 10. In FIG. 3C, the angle is minus 65 degree and in FIG. 3D it is substantially perpendicular to the tangent of the circle.

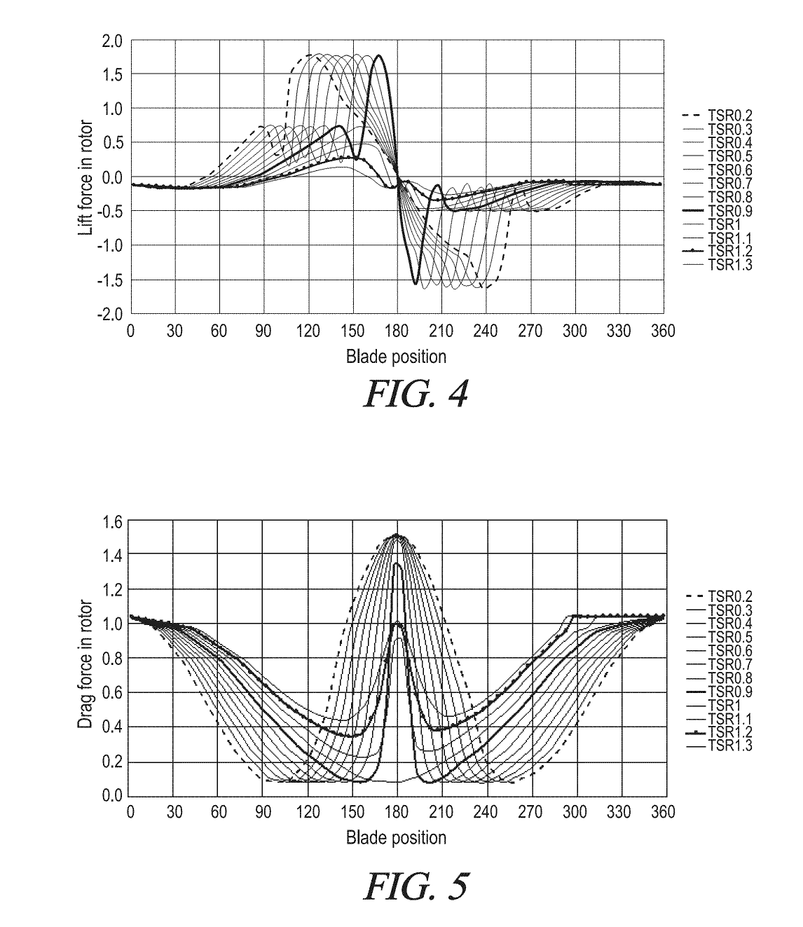

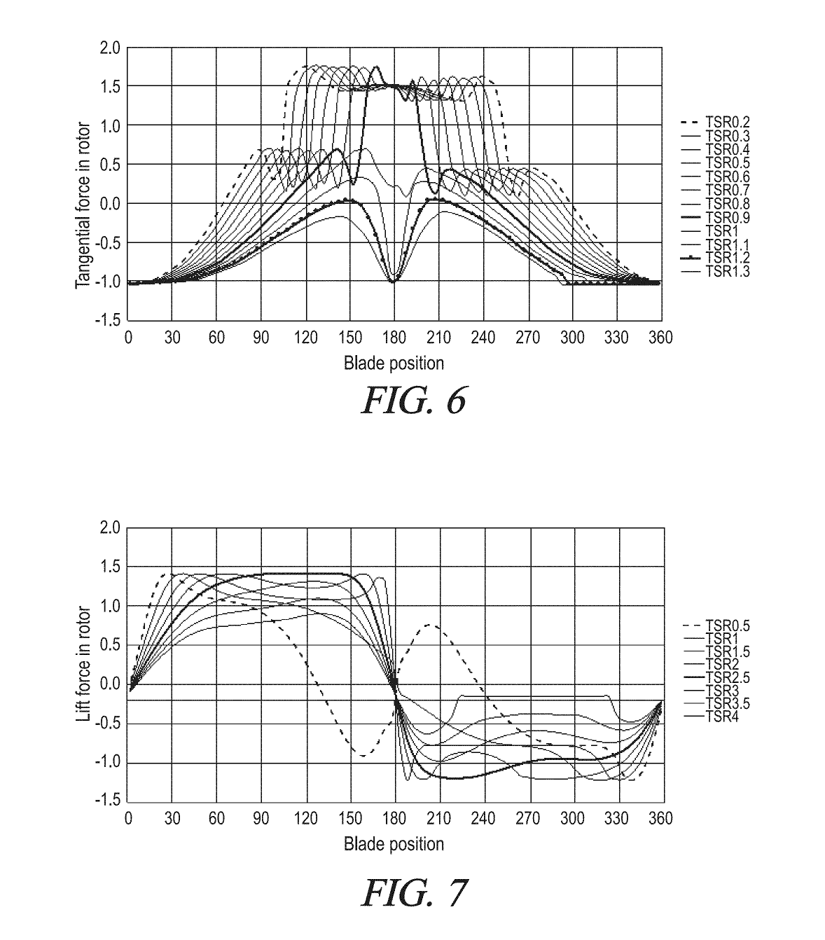

According to Jamieson (2011), vertical axis wind turbines are “sometimes loosely categorized as lift or drag based design.” He goes on to explain that turbines such as a Savonious rotor, “categorized as a drag device, in fact employ significant lift.” Indeed, using a convex airfoil rotor blade, such as shown in FIG. 3D, produces lift in its normal sense. FIG. 4 is a graph showing the lift on one airfoil on such a rotor (FIG. 3D) at different tip speeds. The drag for the same configuration is shown in FIG. 5. The combined force in the tangential direction of the rotor shown in FIG. 3A, which is the driving force producing power of Cₜ*λ, is shown in FIG. 6 for a rotor blade in “drag configuration” for different tip speeds. It is the combined force of the lift and drag from the rotor blade.

As can be seen in FIG. 6, large parts of the rotation have negative force and thereby negative power production. When the rotor 110 approaches a TSR above 1, there is no longer a net positive production of power of a drag-based rotor.

In Jamieson, the maximum Cₚ of such a rotor on a high level is:

Cₚ=0.5·C_{D}·λ˜(1−λ)²,

which then peaks at λ=⅓ with a Cₚ of 2/27*C_{D} The conclusion of Jamieson is that the maximum performance is 0.15, albeit the data in FIG. 6 provides detailed insight into this and can give a more accurate answer based on actual airfoils and actual blade orientation.

The present inventors realized that one way of improving the performance of a drag-based rotor is to shield the stroke of the rotation which is going against the wind, basically eliminating (or more correctly minimizing) the negative force on the airfoil rotor in parts of the rotation cycle (see again FIG. 6).

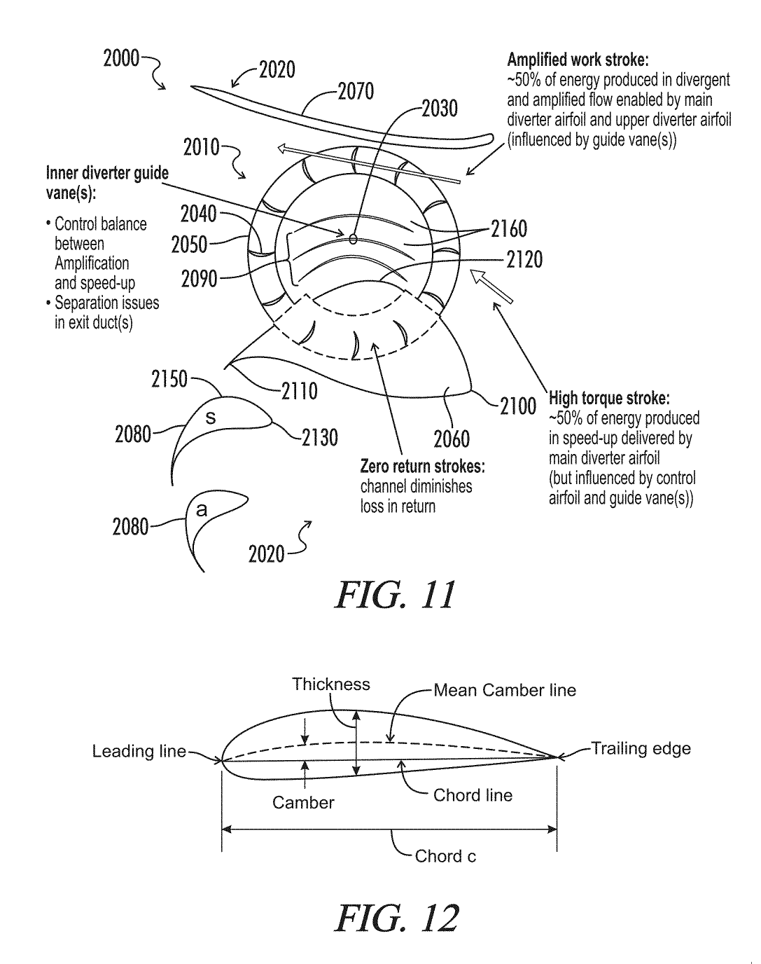

In one embodiment of the present inventors' solutions to the above (shown in FIG. 30), a drag-based rotor is shielded minimizing the negative work in the return stroke, defined from approximately 240 to 360 degrees, continuing from 0 to 60, in FIG. 6 (note also FIG. 11). One important aspect of some embodiments of the diverter assemblies described herein is the combination of inner diverters and the return stroke shielding. The inner diverters' upwards induced lift in FIG. 6 essentially makes the air completely still in the return stroke significantly, or almost completely, eliminating the potential losses.

A second aspect of the present inventors' work in drag-based solutions is the torque stroke (note again FIG. 11), which is approximately from 60 degrees to 120 degrees in FIG. 6. As can be seen by comparing FIGS. 4 and 5, this part of the stroke has relatively high lift and corresponding low drag, at least at low tip speed ratios, i.e., it is lift based in this stroke. The present inventors have surprisingly found that one benefit of a flapped main diverter, inner diverter and outer diverter combination, is significant acceleration of the ambient air, which occurs because of the unique geometry. In principle, more blades will produce more torque, thus, more power. Nevertheless, at some speed the angles of airflow to the rotor becomes such that this part of the stroke produces negative power, regardless of the amplification.

The work stroke, from approximately 60 to 240 degrees rotor position in FIG. 6 (note also FIG. 11), is mostly driven by drag. It is possible to envision the airfoil being carried by the wind and thereby producing power. Unlike the torque stroke, in the work stroke too many airfoils will start shading for each other and will not provide any additional benefit. Also, the airfoil cannot travel faster than the local velocity (local tip speed of ˜1). In fact, referencing Jamieson again, λ=⅓ being optimal, it would be necessary to have a local velocity increase of about 3 to get to λ˜1 and thereby produce a reasonable power contribution. Note that while this explains the function of the acceleration, the actual system performance is coupled and much more complicated than mere superposition. In this, the configurations proposed by the present inventors herein do provide that result in the throat of the rotor system, i.e., between an inner diverter and an upper minor diverter of the diverter system.

The remaining part is the return path from the work stroke, back into the return duct. This part has no particular logics or labeling, which in any event is labeling solely for the purpose of the research and development of the system.

In summary, the present inventors realized, based on the above research and analysis, that the principle of getting more power out of a “drag-based” rotor is a combination of adequately shielding the return stroke, amplifying the torque stroke with high speed up effects, amplifying the speed up effects in the work stroke, modifying the return path so as not to have negative impact. The inventors further realized that one successful approach to expand the operational envelope of such a system is an asymmetrical rotor airfoil.

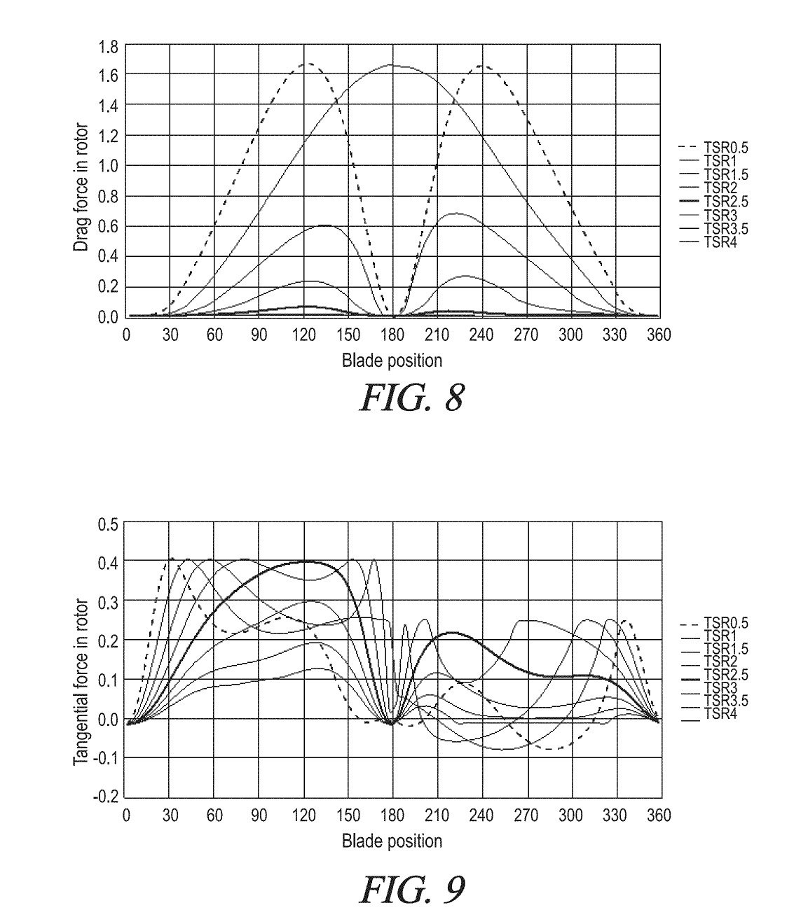

In FIGS. 7-9, lift, drag and tangential forces are shown. It is observed that for an optimal speed, which in the example is about λ˜2.5, the rotor shows a distinct lift across all rotor positions and a corresponding almost no drag anywhere. The 90-degrees position is the upwind location, and the 270 degrees position is the downwind location. The combined force at the optimal speed is almost entirely positive. Inserting this rotor in the same geometry as the drag rotor (note again FIG. 30) will provide similar positive effects due to the speed up effects, such as discussed above, and the return path challenge mentioned above, almost solves itself (see FIG. 31). One significant benefit of the specific configuration is that the return stroke (˜360 degree) is shielded and thus the negative power produced at low rotor speeds is negated.

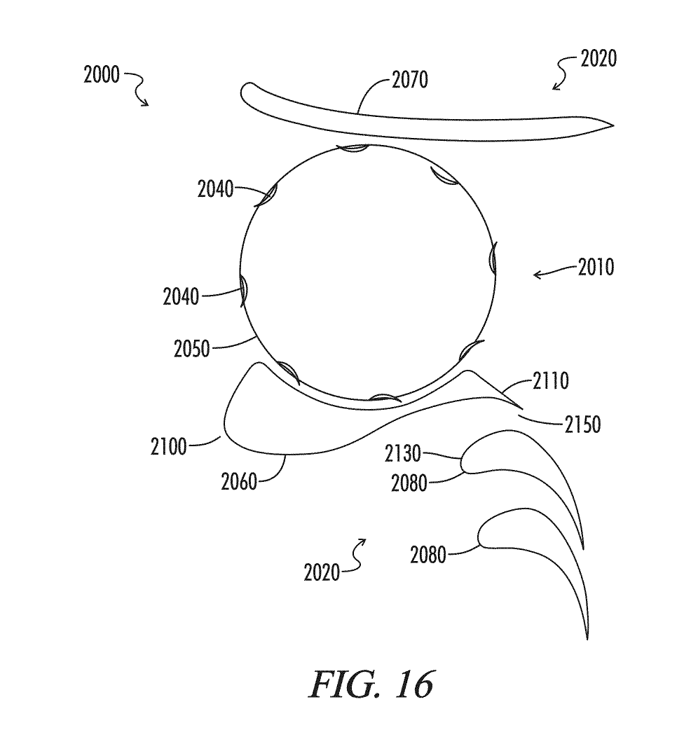

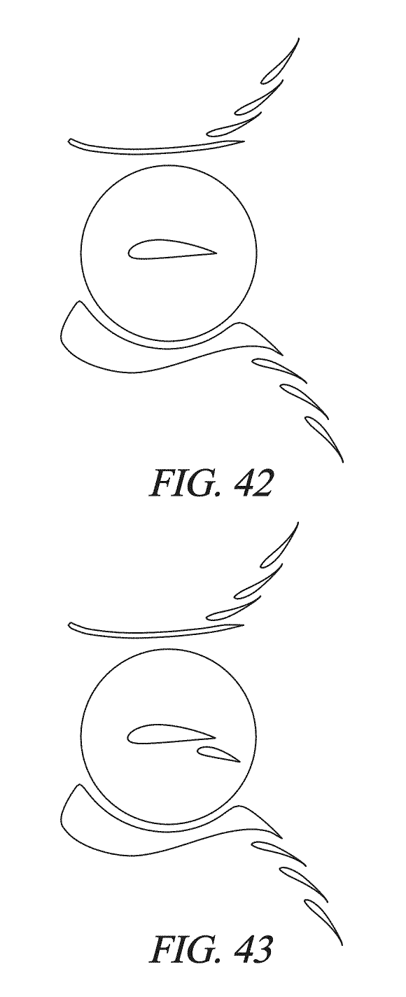

The inventors also realized that unlike a drag-based rotor, a lift-based rotor may not benefit as much from a throat-like design using multiple stacked inner diverters, so such may be left out of the design configuration (note FIG. 16). However, for structural reasons, such as supporting lift-based rotors, one or more inner diverter may be used to deflect wind from a rotation shaft (note, for example, FIGS. 41-43).

As discussed above, the characteristics for the free rotor shown in FIG. 6 have been realized by the present inventors through significant efforts in investigating different airfoil configurations. Ordinarily, a drag-based rotor is assumed to have a cup-like airfoil shape, in order to increase drag in the downwind stroke and reduce drag in the upwind stroke.

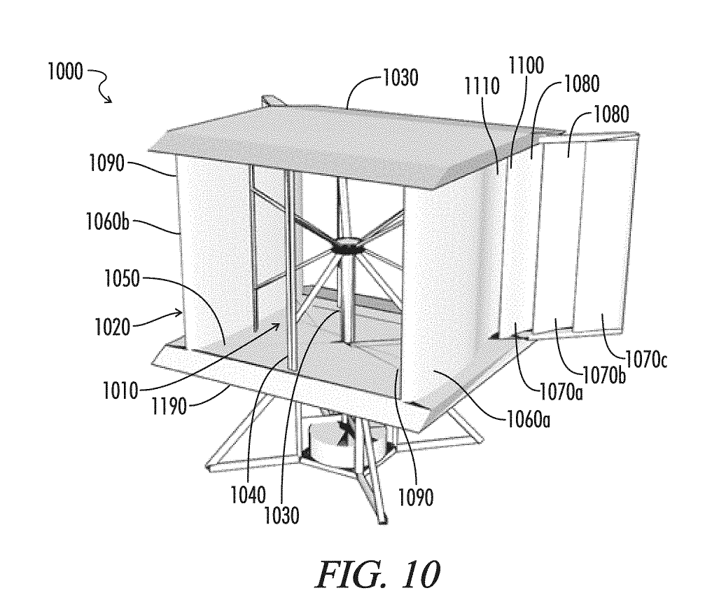

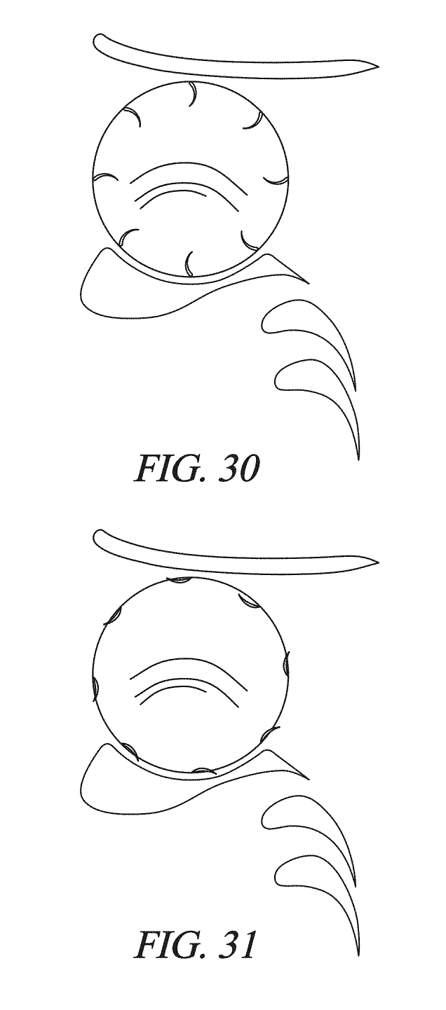

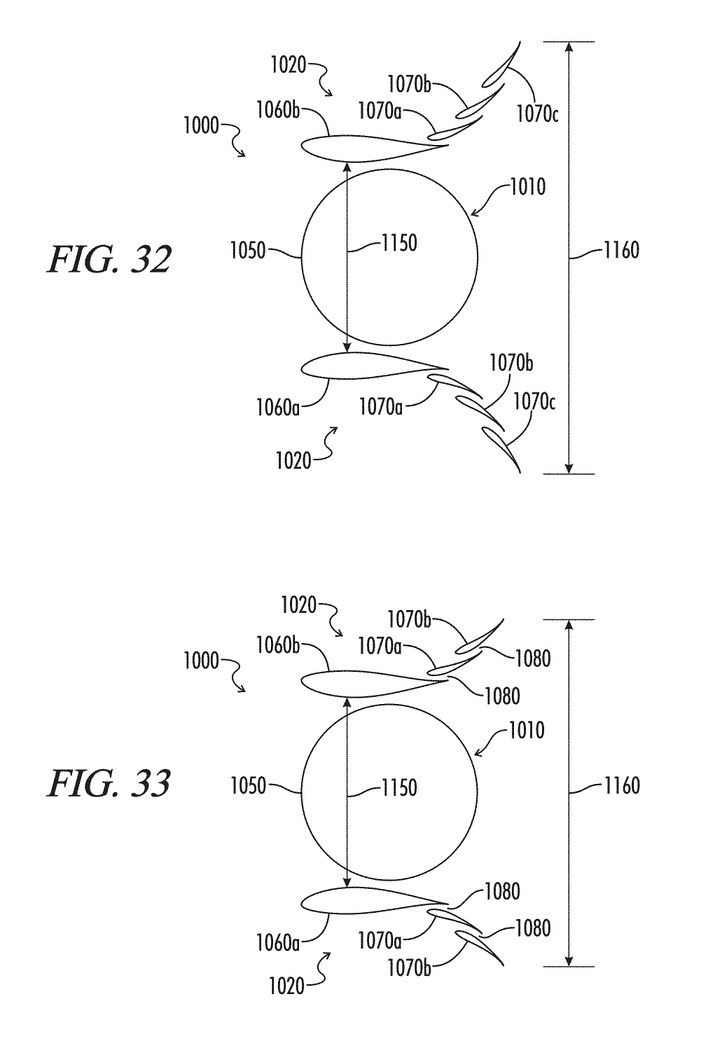

FIG. 10 depicts one embodiment of a wind power generating rotor system 1000 according to the present disclosure, and FIG. 32 illustrates a horizontal section of most components of the embodiment of FIG. 10. As shown, rotor system provides a rotor assembly 1010 and a diverter assembly 1020. The rotor assembly has a rotor axis 1030, typically arranged vertically, and a plurality of rotor blades 1040. The rotor blades 1040 are structured and arranged for rotation around the rotor axis 1030 along a rotation path 1050 in response to wind passing the rotor blades. Accordingly, the rotor assembly 1010 captures kinetic energy from wind.

The diverter assembly 1020 is arranged adjacent to or surrounding the rotor assembly 1010, and typically comprises a plurality of diverters arranged at one or both of inside and outside the rotation path 1050 of the rotor blades 1040 of the rotor assembly.

As shown, in the embodiments of FIGS. 10 and 32, the plurality of diverters are arranged outside the rotation path 1050, and the diverter assembly may be symmetric, or quasi-symmetric. The plurality of diverters may comprise at least one primary diverter 1060, or in the embodiment shown, two primary diverters 1060a, b. As shown, the plurality of diverters may further comprise flap diverters 1070, in this case, each of the primary diverters 1060a, b, has three associated flap diverters 1070a, b, c. In places in this discussion, the flap diverters will be referred to herein based on the primary diverter from which it extends, referring to flap diverter 1070ab as the “b” flap diverter associated with the “a” primary diverter.

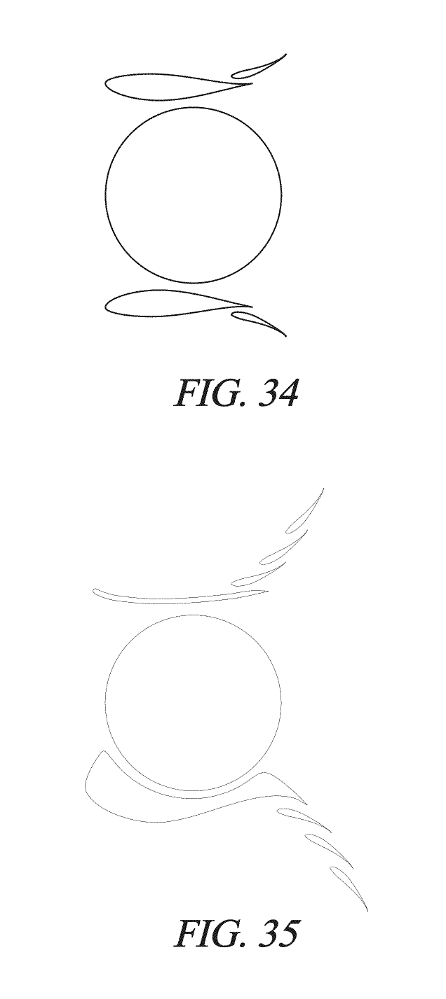

While the embodiment shown provides at least one flap diverter 1070 associated with each primary diverter 1060, the other embodiments may apply flap diverters to only one or the other of the primary diverters. Further, while the embodiment shown includes three flap diverters 1070 associated with each primary diverter 1060, it will be understood that only one flap diverter may be associated with each primary diverter as shown in FIG. 34, or two flap diverters may be associated with each primary diverters, as shown in FIG. 33.

Similarly, while the embodiment described now is symmetric, asymmetric embodiments are contemplated as well, and will be described in detail below.

In most of the embodiments shown wind approaches the wind power generating rotor system 1000 from the left of the page. As such wind first encounters a leading edge 1090 of each of the primary diverters 1060a, b, and the flap diverters 1070 are in the lee of the corresponding primary diverter.

As shown, the diverters are generally provided with a two dimensional airfoil profile, and they extend in a direction generally tangential to the rotation path 1050 of the rotor assembly 1010.

Further, a gap 1080 is typically provided between the diverters of the assembly, such that air can pass between a primary diverter 1060 and its associated flap diverters 1070, and between the secondary diverters themselves. Further, as shown, a leading edge 1100 of the first flap diverter 1070aa in a sequence is adjacent the trailing edge 1110 of the corresponding primary diverter 1060a.

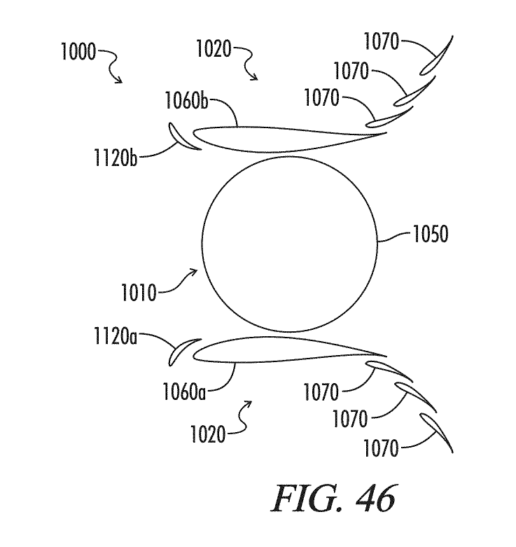

In some embodiments, such as that of FIG. 46, in addition to the primary diverters 1060 and the flap diverters 1070, slot diverters 1120 are provided and associated with each of the primary diverters. Accordingly, the slot diverter 1120a associated with the first of the primary diverters 1060a is adjacent the leading edge 1090 of the corresponding primary diverter.

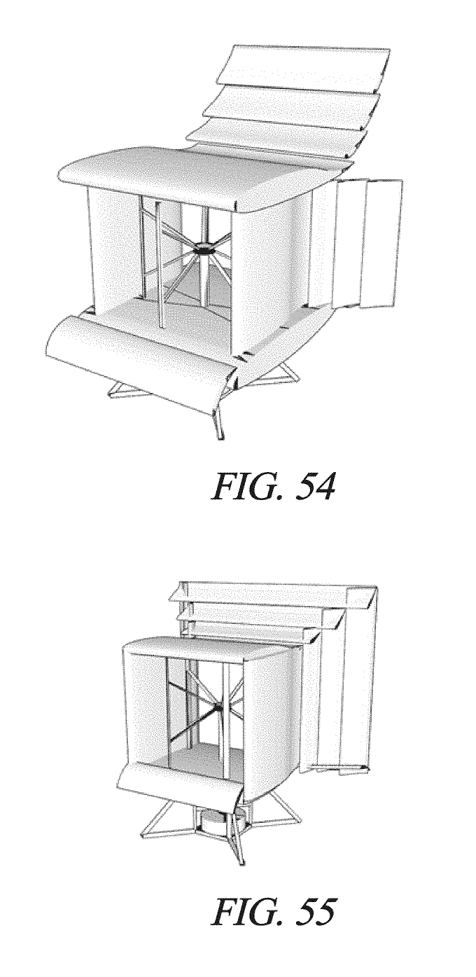

As further shown in FIG. 10, a top endplate 1130 and a bottom endplate 1140 may be located perpendicular to the rotor axis 1030. These endplates 1130, 1140 may be shaped to function as diverters as well. Accordingly, while most embodiments shown and discussed herein are shown in two dimensions, it will be understood that three dimensional embodiments are contemplated as well. Some examples of such embodiments are shown below in FIGS. 54 and 55, in addition to that of FIG. 10.

In some embodiments, the flap diverters 1070 are connected to the primary diverters, while in others they are positioned near the primary diverters by a separate superstructure. For example, the endplates 1030, 1040 may retain the various diverters, or extensions 1170 of the endplates may be provided for locating the diverters.

As discussed at length above, the design of the diverter assembly 1020 and the placement of the individual diverters may be optimized to increase an expansion ratio of the rotor system. As discussed at length above, the expansion ratio Aₑₓᵢₜ/Aᵣₒₜₒᵣ is based on the ratio of the rotor area Aᵣₒₜₒᵣ, shown as 1150 and an exit area Aₑₓᵢₜ, shown as 1160. Accordingly, the number of flap diverters 1070 may be increased specifically in order to allow for an expansion of the exit area Aₑₓᵢₜ, which in turns increase the expansion ratio.

While the embodiments have been discussed in relation to a vertical axis wind turbine, it will be understood that similar diverter assemblies may be incorporated into horizontal axis turbines, as will be discussed in more detail below. In horizontal axis wind turbines, it is beneficial to orient the rotor such that it is perpendicular to the wind direction, while such considerations are moot in the case of a vertical axis turbine.

Further, while the embodiments show diverters of the diverter assembly 1020 located outside of the outside the rotation path 1050 of the rotor blades 1040, it will be understood that diverters may further be placed inside the rotation path 1050, such as at a center of the circle formed by the rotation path. While these internal diverters are more common in asymmetric configurations, as discussed below, they may occur in symmetric configurations in order to, for example, guide airflow around the axis shaft 1030.

As shown in FIGS. 11, 13-20, among others, a wide variety of asymmetric configurations for a diverter assembly 2020 for a wind power generating rotor system 2000 are contemplated.

As in the symmetric embodiments previously discussed, the rotor system 2000 provides a rotor assembly 2010 and a diverter assembly 2020. The rotor assembly 2010 has a rotor axis 2030, typically arranged vertically, and a plurality of rotor blades 2040. The rotor blades 2040 are structured and arranged for rotation around the rotor axis 2030 along a rotation path 2050 in response to wind passing the rotor blades. Accordingly, the rotor assembly 2010 captures kinetic energy from wind.

As shown, in asymmetric configurations of the rotor system 2000, the diverter assembly 2020 typically comprises a primary diverter 2060 and a secondary diverter 2070, as well as at least one flap diverter 2080. Further, in many asymmetric configurations, the diverter assembly further comprises at least one internal diverter 2090 located within the circle formed by the rotation path 2050 of the rotor blades 2040.

As shown, the primary diverter 2060 and the secondary diverter 2070 are located opposite the rotor assembly 2010 from each other, and they have different profiles from each other. Typically, the flap diverters 2080 are located in the lee of the primary diverter 2060. While the primary diverter 2060 may not be shaped as a typical airfoil, it still has a leading edge 2100, which is the edge first encountered by approaching wind, and a trailing edge 2110. Further, as shown in FIG. 11, the primary diverter 2060 may, in combination with an internal component 2120 of the diverter assembly, form an airfoil shape enveloping at least part of the rotation path 2050. Accordingly, in some embodiments, the primary diverter 2060 has an airfoil shape that abuts the rotation path 2050, and the rotation path passes through and disrupts a portion of the airfoil shape.

Typically, the flap diverters 2080 are located adjacent the trailing edge 2110 of the primary diverter 2060. As shown, while the primary diverter 2060 typically has a complex two dimensional profile, such as a portion of an airfoil or a combination of wedges, and typically has a varying thickness, the secondary diverter 2070 may comprise a flat or curved plate, having a simple two dimensional profile. Accordingly, a leading edge 2130 of a flap diverter 2080 may be adjacent the trailing edge 2110 of the primary diverter 2060.

Further, a gap 2150 is typically provided between the diverters of the diverter assembly 2020, such that there is a gap between the primary diverter 2060 and a corresponding flap diverter 2080, and there is another gap between multiple flap diverters.

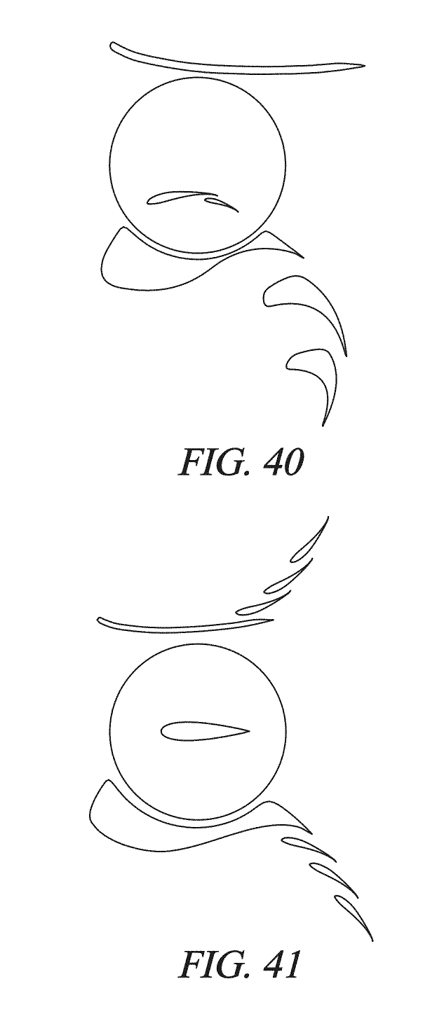

As shown, an internal diverter 2090 may be provided that comprises a plurality of generally flat elements, such as plates 2160, provided in a stacked configuration to form a diverter. In other embodiments, such as that shown in FIG. 40-43, the inner diverter 2090 may take the form of one or more airfoils.

Either the symmetric or asymmetric configurations of the diverter assemblies 1020, 2020, may be used in either the lift based or drag based configurations of rotor blades 310 shown in FIGS. 3A-D. However, lift based configurations, as shown in FIG. 3A, are generally associated with the symmetric configurations of diverter assemblies 1020 described herein, while drag based configurations, as shown in FIG. 3D, are generally associated with the asymmetric configurations of diverter assemblies 2020 described herein. Further, it will be understood that, as discussed elsewhere, the typically implemented embodiments are not purely lift based or purely drag based, and are instead somewhere in between, such as those orientations shown in FIGS. 3B and 3C.

Accordingly, as shown in, for example, FIGS. 11, 13, 14, 15, and 17-19, the asymmetric configurations are usually illustrated with rotor blades 2040 shown in the drag based configuration, with the rotor blades substantially perpendicular to the perimeter of the rotation path 2050. Although some exceptions are shown, such as FIG. 16, this is because the asymmetric configuration is designed to direct airflow towards the blades in a workstroke flow zone, i.e., where the wind interacts with the scooped side of the blade, and to shield the return stroke of the blades.

Similarly, as shown in FIG. 10, the symmetric configurations are usually illustrated with rotor blades 1040 shown in a lift based configuration, with the rotor blades substantially tangential to the perimeter of the rotation path 1050.

In either the symmetric or asymmetric configurations, the system may further be provided with an airgap, taking the form of a predetermined gap 3000 between a diverter adjacent the rotation path 1050, 2050. While such a gap is typically minimized in the context of rotor assemblies with diverters in the prior art, some of the present embodiments are deliberately provided with substantial predetermined gaps 3000.

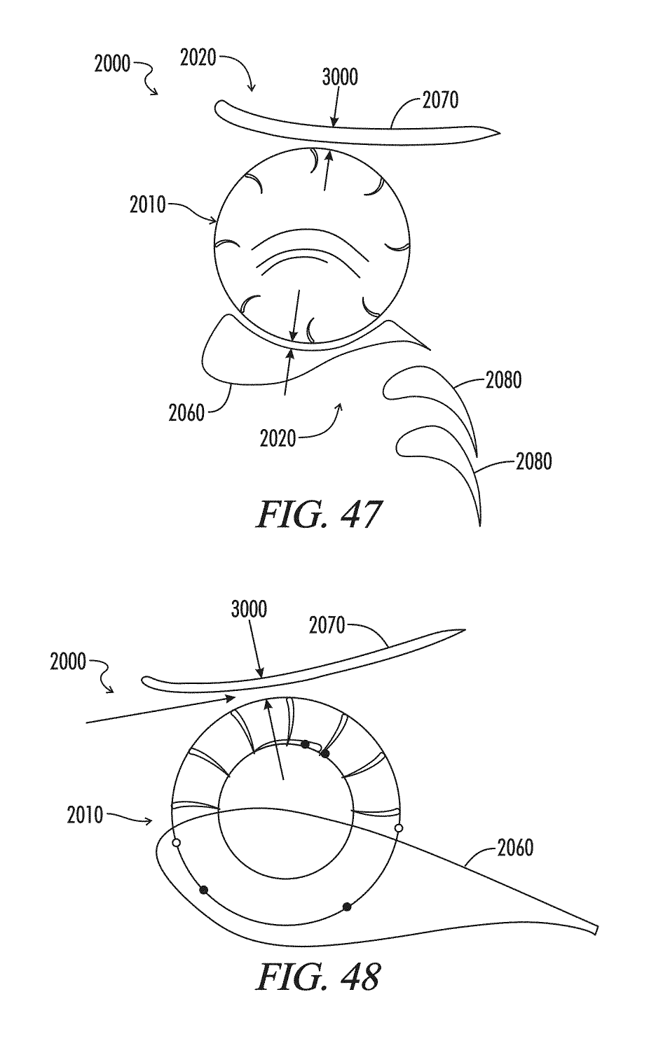

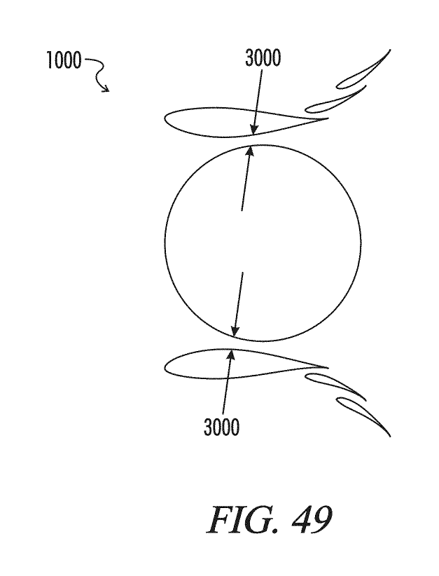

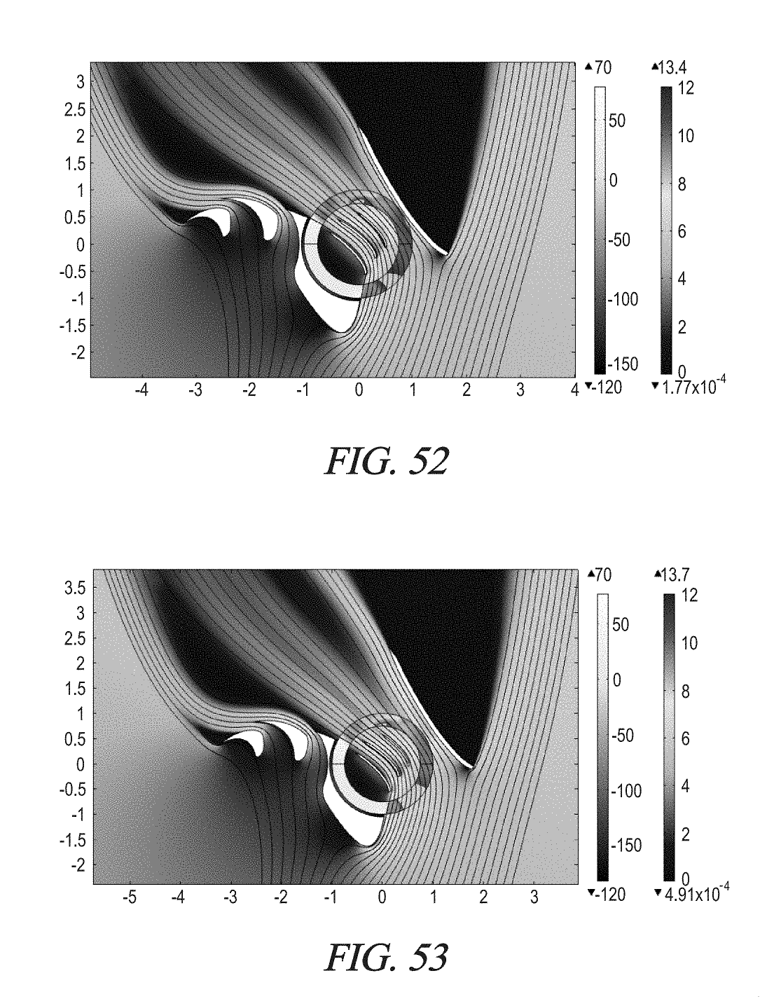

Such gaps are shown in asymmetric configurations of the diverter assembly 2020 in FIGS. 47 and 48, and in a symmetric embodiment in FIG. 49. Further FIG. 52 shows the airflow associated with an asymmetric configuration of the diverter assembly 2020 provided with traditional tight tolerances between a secondary diverter 2070 and a rotor path 2050, and FIG. 53, in contrast, shows the airflow associated with providing an asymmetric configuration of the diverter assembly 2020 with a substantial airgap 3000.

As shown, the predetermined gap 3000 is between approximately 3.5% and 25% of a diameter 3010 of the perimeter of the rotation path 2050. In some embodiments, the predetermined gap 3000 is approximately 15% of the diameter 3010 of the rotation path 2050.

When such a gap 3000 is provided, bypass flow through the air gap 3000 between the rotor blades 2040 and the relevant diverter 1060, 2070 may stabilize the robustness of the airflow towards velocity fluctuations (which may otherwise result in turbulent flow). For specifically, the bypass flow may be accelerated as it passes through the air gap 3000, and may thereby create a stable boundary layer on the diverter, which can prevent the onset of stall, even when the diverter is set to a high wake expansion angle.

Accordingly, and for other reasons, such a configuration may enhance power extraction in the embodiments described. Further, if applied as an active control feature, the diverter can perform slight rotational or translational movement during operation to actively balance the bypass flow rate.

Further, in some embodiments, diverter structures may be provided with flexibility, such that abnormal and gusting winds result in an automatic adjustment of the gap 3000.

In asymmetric configurations, as shown, tight tolerances may be maintained between the primary diverter 2060 and the perimeter of the rotation path 2050, while a gap may be provided between the secondary diverter 2080 and the rotation path 2050.

In symmetric configurations, as shown in FIG. 49, gaps 3000 may be provided between the primary diverters 1060 and the perimeter of the rotation path 1050.

Accordingly, when the gap between the rotor and the diverter is introduced, the flow in the gap, here called the by-pass flow, is accelerated compared to the free stream. In this, the boundary layer of the diverter is stabilized and separation on the diverter is suppressed and the additional by-pass flow suppresses excessive wake expansion behind the rotor and thereby stabilizes the wake, ensuring high efficiency.

Although, the intuitive option, as discussed above, would be to make the gap as small as possible, applicant has discovered unexpected benefits of implementing an airgap 3000 much larger than the smallest possible gaps. In some embodiments, the gap between the rotor and the diverter is defined between the rotor circumference and the diverter where the gap is 25%>X>3.5% of the rotor diameter. If the rotor diameter is 2000 mm, the gap should be bigger than 75 mm. For example, the optimum gap may be 250 mm on a 2000 mm rotor.

In all of the embodiments described here, it is noted that the airfoil selected for a lift-based rotor may be a high-performance airfoil, for example, a symmetrical airfoil like the NACA0009 to NACA0030, where NACA is an acronym well known to people skilled in the art, and examples of such airfoils may be seen at airfoiltools.com. Alternatively, a quasi-symmetrical airfoil designed for high performance may be selected. This could for example be from the well-known NACA4409 to NACA4425 series, or any of the other NACA 4, 5, or 6 digit series airfoils. It is understood that NACA airfoils are not the only airfoils to be considered for optimal configurations of the embodiments disclosed, and that the airfoil configuration is closely related to the configuration of the entire system and the expected performance one desires to achieve. A person skilled in the art will have insight to such choices and trade-off, albeit not specifically to the application described and researched here within.

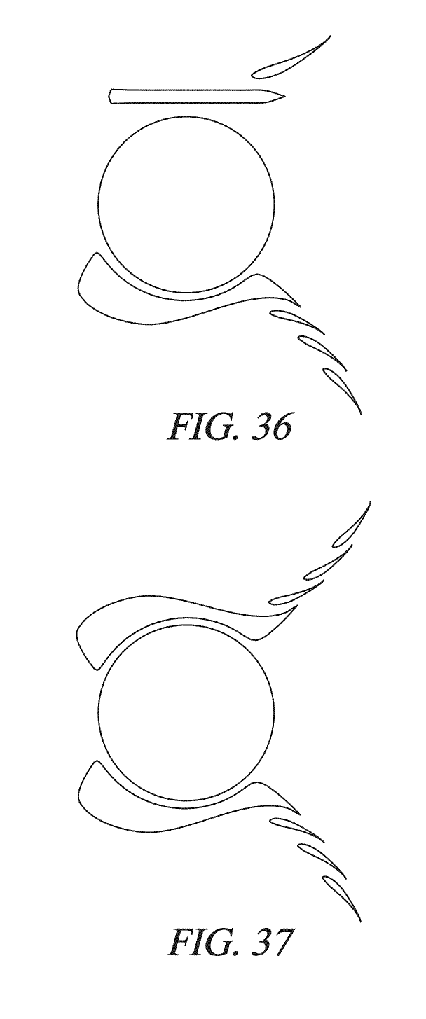

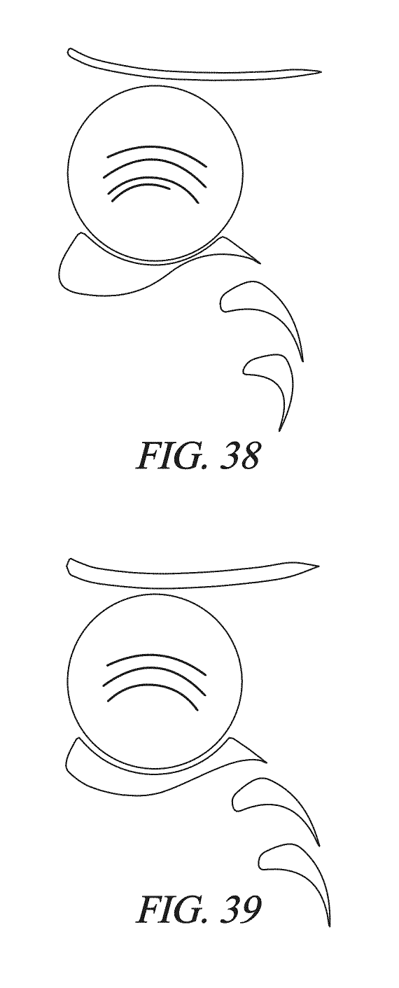

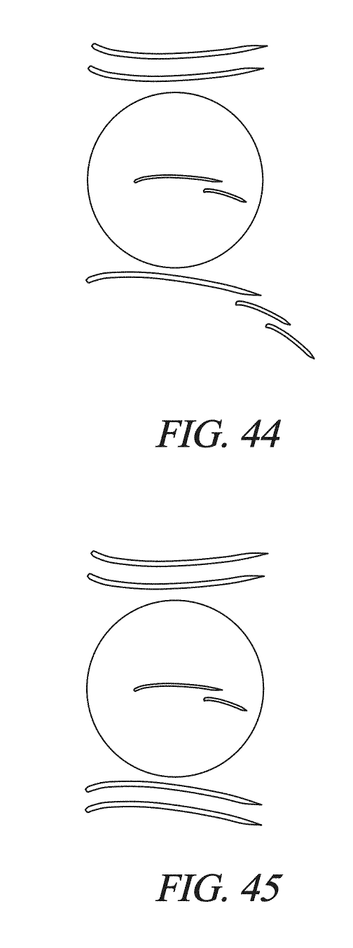

Further, it is noted that the airfoil selected for a drag-based rotor in a diverter augmented system, as shown, for example, in FIGS. 30, 31, 35, 36, 38 to 45, has a height of the camber line that exceed 10% of the chord line. The airfoil shape may be selected from a high-lift airfoil or an assembly of airfoils or an assembly of flat plates or an airfoil-resembling element, such as the Gottingen 417A, known as the GOE417A airfoil from airfoiltools.com. For the embodiment of FIG. 16, for example, an airfoil with a camber line between 0% and 40% may be utilized, or even an inverted camber line may be utilized, corresponding to negative values of camber.

In some embodiments of the present disclosure, the rotor system comprises a vertical diverter assembly that exploits the Venturi effect, such that the mass-flow-rate of air through the VAWT rotor system is enhanced, thereby increasing the potential for power extraction. In certain aspects of the present disclosure, the diverter assembly is asymmetric. The asymmetry of the diverters makes the Venturi flow through the VAWT rotor system become highly non-uniform, with a high velocity part of the flow interacting with the rotor blades during the work-stroke, and a very low velocity part of the flow interacting with the rotor blades during the return-stroke. The benefit of such asymmetry is that work-stroke power production is maximized and return-stroke power sacrifice is minimized.

The diverters may be slotted, such that the aerodynamic shape of one or both of the two sides is composed by a sequence of airfoils instead of just one airfoil. Arranging airfoils in a carefully geometrically designed sequence is done in order to exploit the flap-effect, i.e., to allow a certain amount of by-pass flow through the channels/slots such that a higher overall curvature of the flow can be obtained without stalling the flow. The higher curvature of the airfoil sequence will deflect the flow more, and thereby create more lift (i.e., more suction) of the flow through the rotor positioned in the throat of the diverter system, enhancing the mass-flow-rate and increasing potential for power extraction. Exploitation of the flap-effect is known from, e.g., the aircraft industry, where commercial aircrafts use flaps to increase the lift-force upon take-off and landing.

One problem circumvented by such diverter assemblies is the one earlier described that a silent low TSR VAWT cannot be power-efficient because of drag force losses. With the asymmetric slotted diverter, drag-losses are minimized due to asymmetry and overall potential for power extraction enhanced due to a very strong Venturi effect made possible by the slotted diverter airfoil configurations.

While these multi-element diverters can be arranged as classical flapped and/or slotted airfoils, it is important to note that the functionality only in part is as a classical airfoil.

In this case, the air mixing which occurs in the gaps provides the high lift of the diverter, which in turn gives high speed up and thereby high efficiency of the embedded rotor. However, the bypass flow also supports stabilization of the wake region behind the rotor. The “wake region” is used in two senses here, the first of which is that of the airfoils and diverters themselves. The second sense is the wake region for the wake produced by the rotor power extraction efforts. The two are closely related to the joint and entire system performance. This is a function which is normally not effective in a multi-element airfoil, such as on an airplane wing.

In some embodiments, the device comprises one or more inner diverters, for example, vertical stator blades that are positioned inside the inner swept perimeter of the VAWT rotor blades. Such an inner diverter acts as an aerofoil, which through generation of a lift force will bend the passing flow and, as for any airfoil, create a pressure side and a suction side. The mass-flow-rate on the suction side will be high due to the decreased pressure. This is Bernoulli's principle along a streamline: A decrease in pressure will be associated with an increase in flow velocity, and vice versa. Contrarily, the mass-flow-rate on the pressure side will be low due to the increased pressure. Thus, the consequence of applying an inner diverter is to enhance the asymmetry of the flow passing the VAWT rotor. Asymmetry of the flow passing the VAWT rotor results in the flow velocity of the wind passing through the work stroke zone being increased, thereby increasing the potential for taking power out of the wind (electric power generation). Also, the flow velocity of the wind passing through the return stroke zone is decreased, thereby decreasing the sacrificed (lost) power when the rotor blades rotate back against the wind.

The problem circumvented by the inner diverter(s) is the one earlier described that a silent low TSR VAWT cannot be power-efficient because of drag force losses. With the inner diverter(s), drag-losses are minimized due to asymmetry and overall potential for power extraction is enhanced.

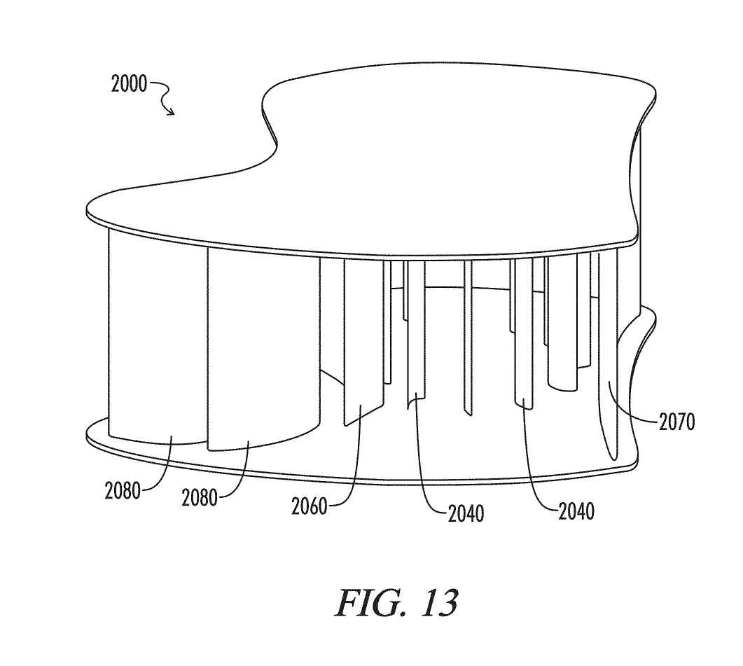

FIG. 13 illustrates a slotted asymmetric diverter VAWT 2000, as seen from behind in a perspective view, having rotor blades 2040, bottom endplate 2200 and top endplate 2210, high-lift primary diverter 2060, high-lift flap diverters 2080 and a low-lift secondary diverter 2070. As shown, the rotor assembly 2010 is located within the confines of the diverter assembly 2020.

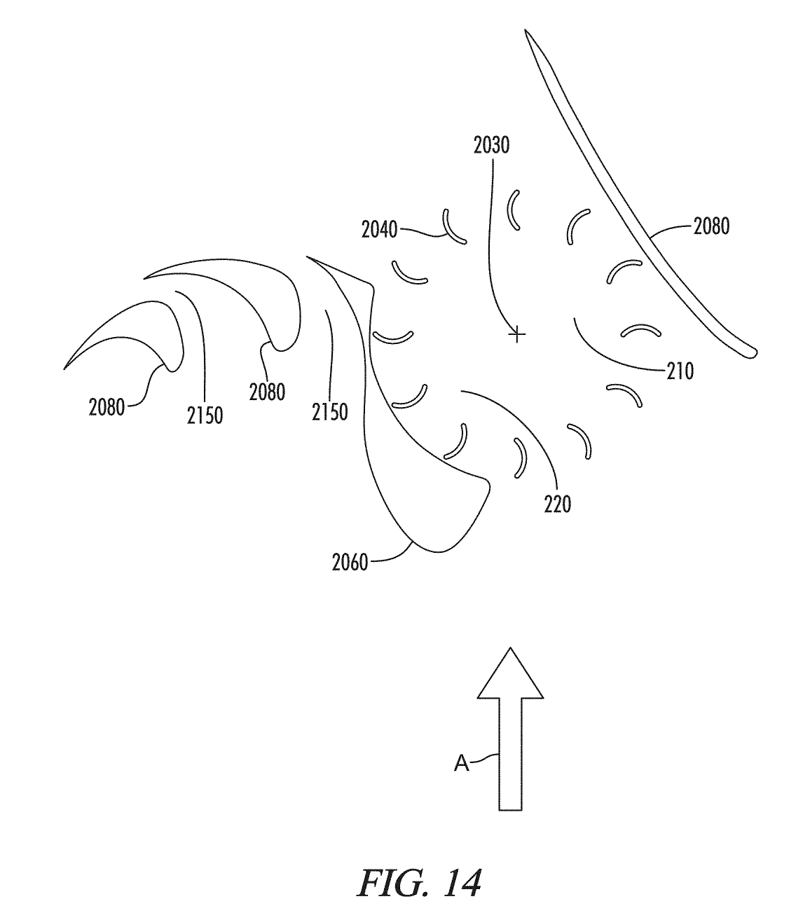

FIG. 14 illustrates a cross section of a slotted asymmetric diverter VAWT with a double slotted 2150 high-lift diverter assembly comprising a primary diverter 2060 and two flap diverters 2080. The embodiment further comprises a low-lift secondary diverter airfoil 2070. A high-velocity work-stroke flow zone 2220 and a low-velocity work-stroke flow zone 2230 are indicated in FIG. 14 as well.

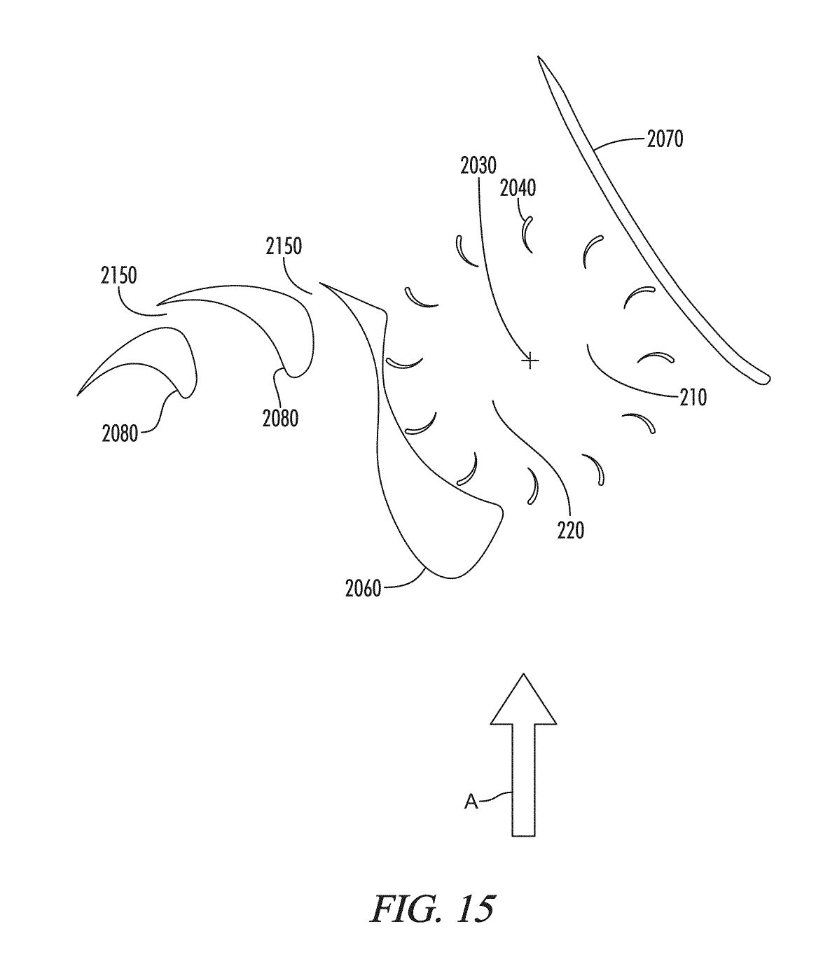

FIG. 15 illustrates a cross section of a slotted asymmetric diverter VAWT similar to FIG. 14, but with airfoil rotor blades 2040 instead of the curved plate rotor blades 2040 shown in FIG. 14.

FIG. 16 is a cross sectional representation of a lift-based rotor assembly 2010 having one possible diverter assembly 2020 according to the present disclosure. The diverter assembly 2020 includes a primary diverter 2060, a secondary diverter 2070, and flaps 2080.

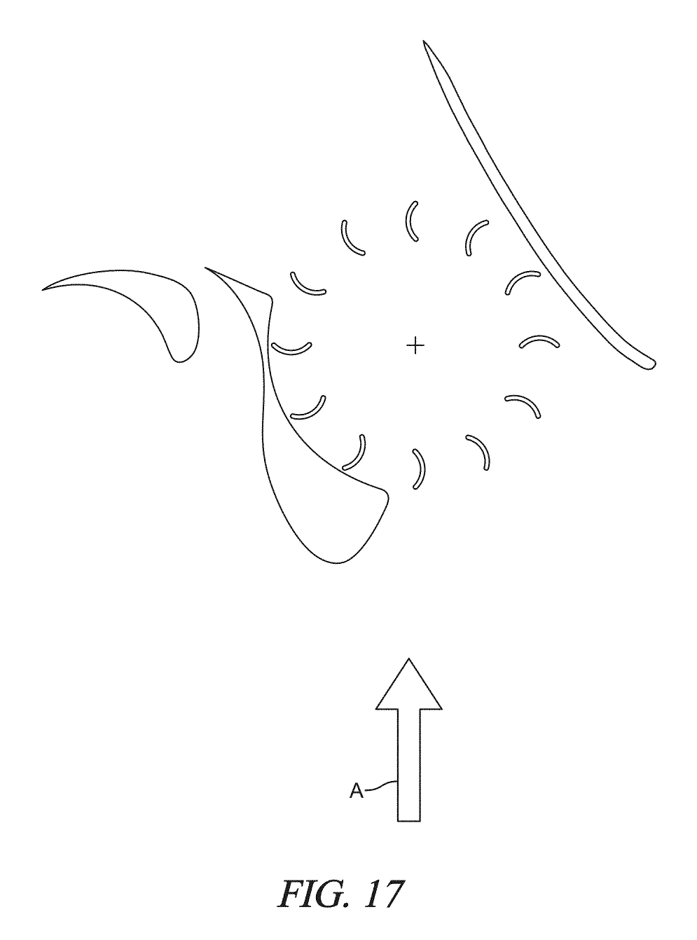

FIG. 17 illustrates a cross section of a VAWT having a slotted asymmetric diverter assembly with a single slotted 2150 high-lift diverter configuration, including a primary diverter 2060 and flap diverter 2080 and a low-lift secondary diverter 2070.

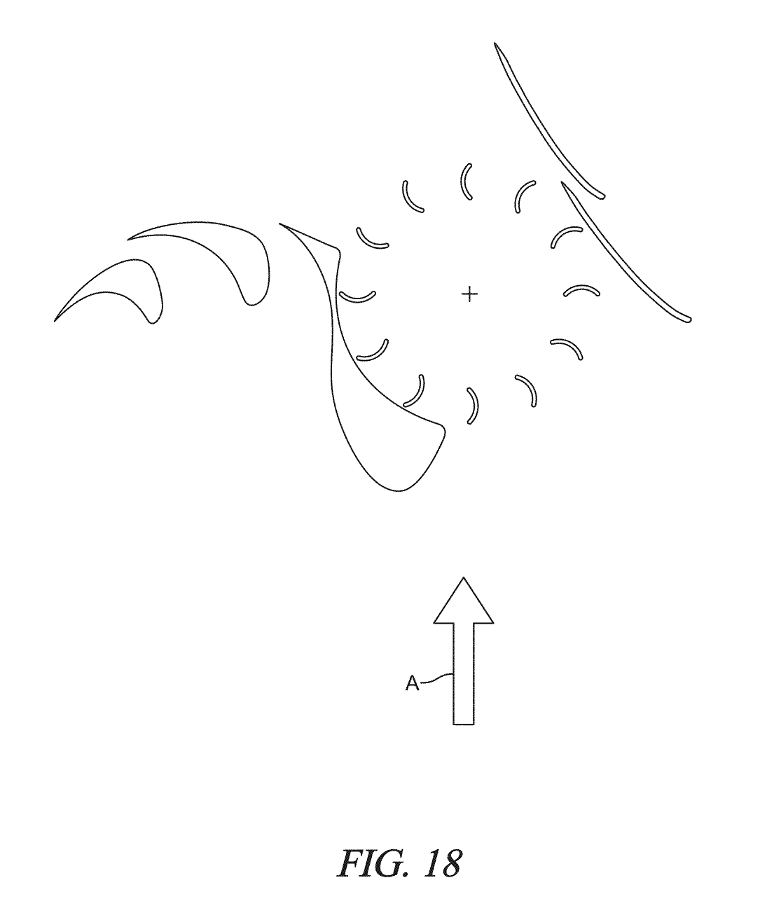

FIG. 18 illustrates a cross section of a slotted asymmetric diverter assembly VAWT with a double slotted 2150 high-lift diverter configuration comprising a primary diverter 2060, two flap diverters 2080, and a single slotted 2150 low-lift diverter configuration comprising two secondary diverters 2070a, b.

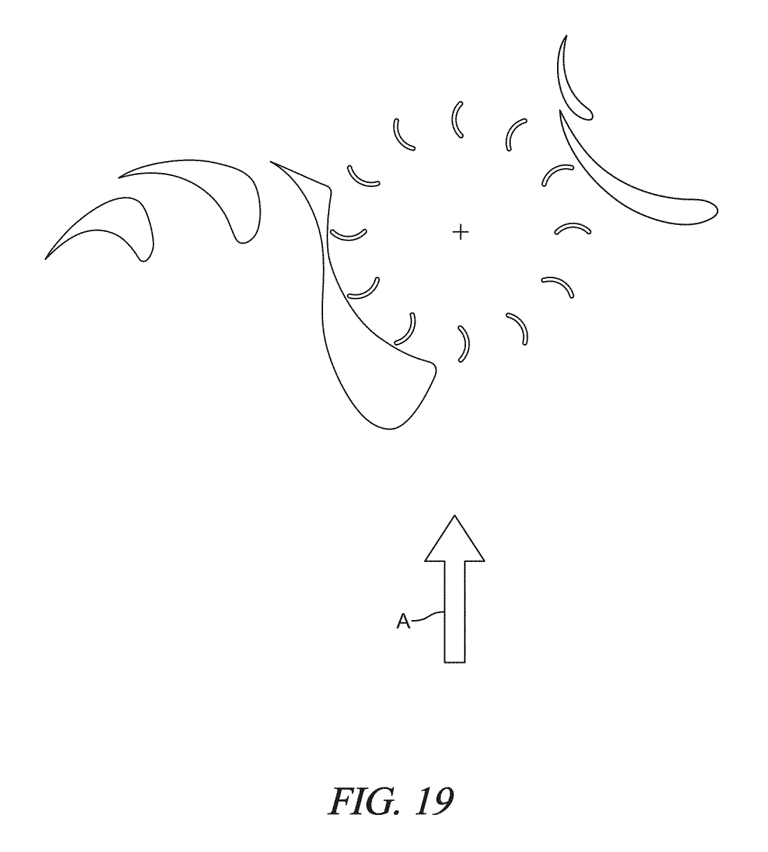

FIG. 19 illustrates a cross section of a slotted asymmetric diverter assembly VAWT as in FIG. 18, but with airfoil-shaped low-lift secondary diverters 2070a, b;

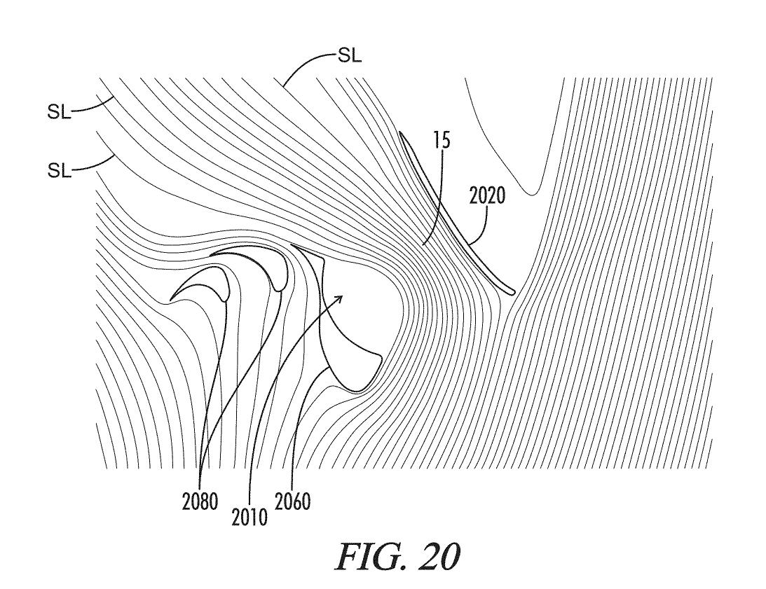

FIG. 20 illustrates a cross section of a slotted asymmetric diverter assembly VAWT with a double slotted high-lift diverter configuration including the primary diverter 2060, two a secondary diverter 2070, and two flap diverters 2080. The diverter is shown with a streamline SL visualization of airflow through the diverter assembly and with the rotor assembly 2010 removed for clarity.

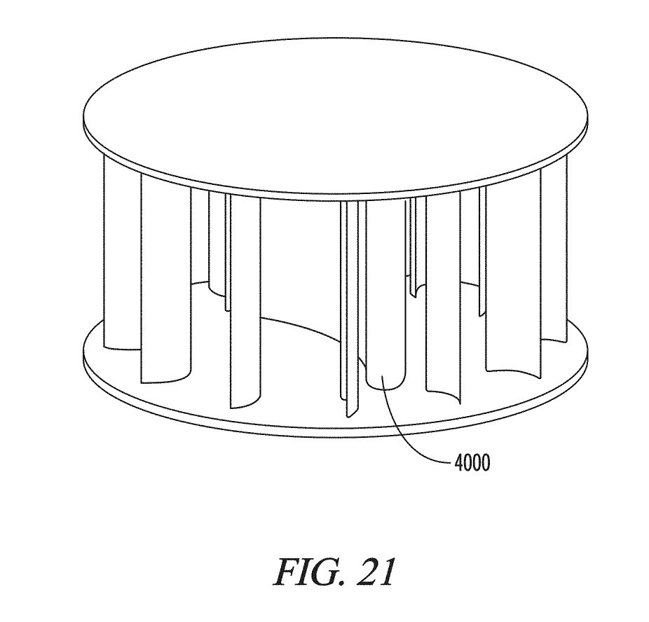

FIG. 21 illustrates a VAWT 2 with a single airfoil-shaped internal diverter 4000 as seen in perspective.

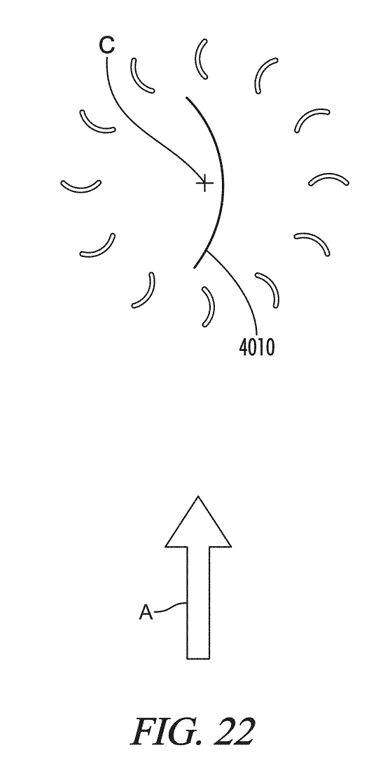

FIG. 22 illustrates a cross section of a VAWT with a single curved plate internal diverter 4010.

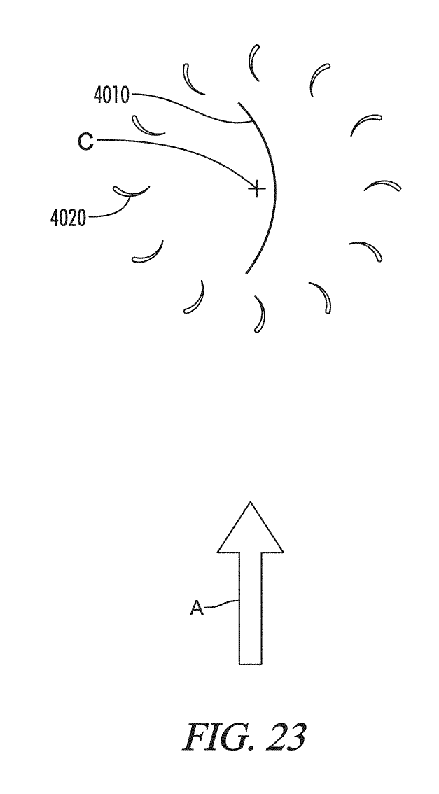

FIG. 23 illustrates a cross section of a VAWT with airfoil-shaped rotor blades 4020, and with a single curved plate internal diverter 4010.

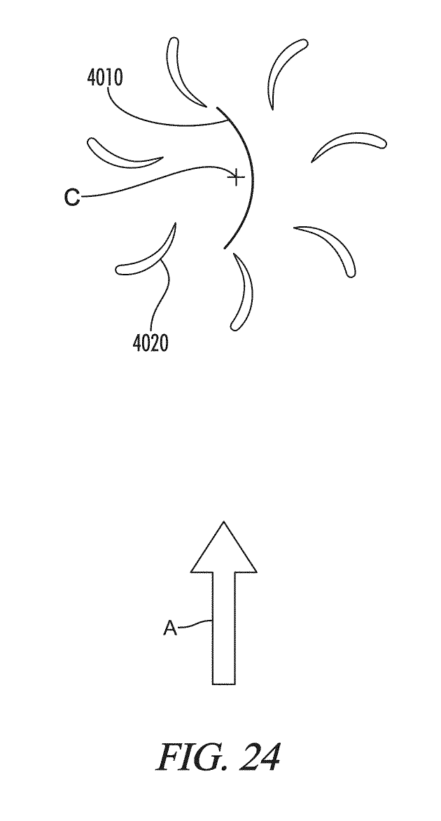

FIG. 24 illustrates a cross section of a VAWT similar to FIG. 23 with differently sized and numbered airfoil-shaped rotor blades 4020, and with a single curved plate internal diverter 4010.

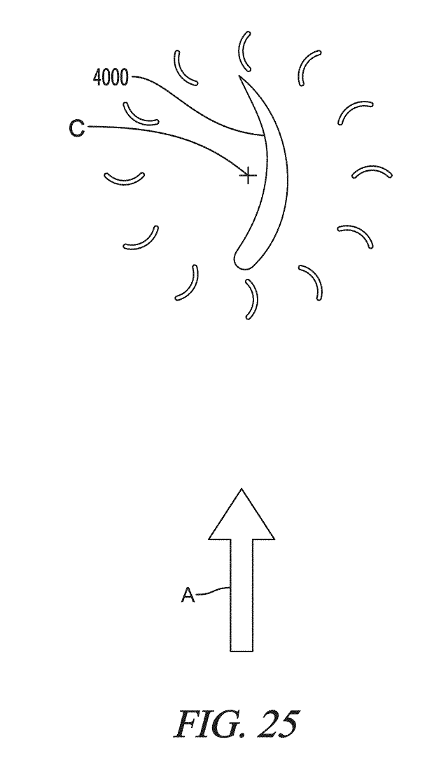

FIG. 25 illustrates a cross section of a VAWT with a single airfoil-shaped internal diverter 4000.

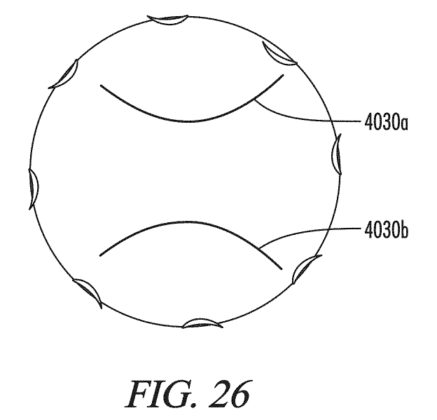

FIG. 26 illustrates a cross section of a VAWT with a pair of curved plate internal diverters 4030a, b shown in a symmetric configuration.

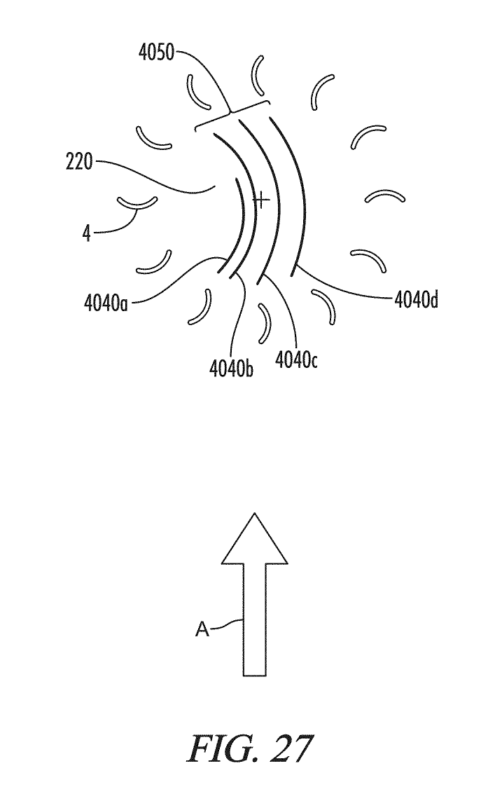

FIG. 27 illustrates a cross section of a VAWT with multiple curved plates 4040a, b, c, d combining to form an internal diverter assembly 4050.

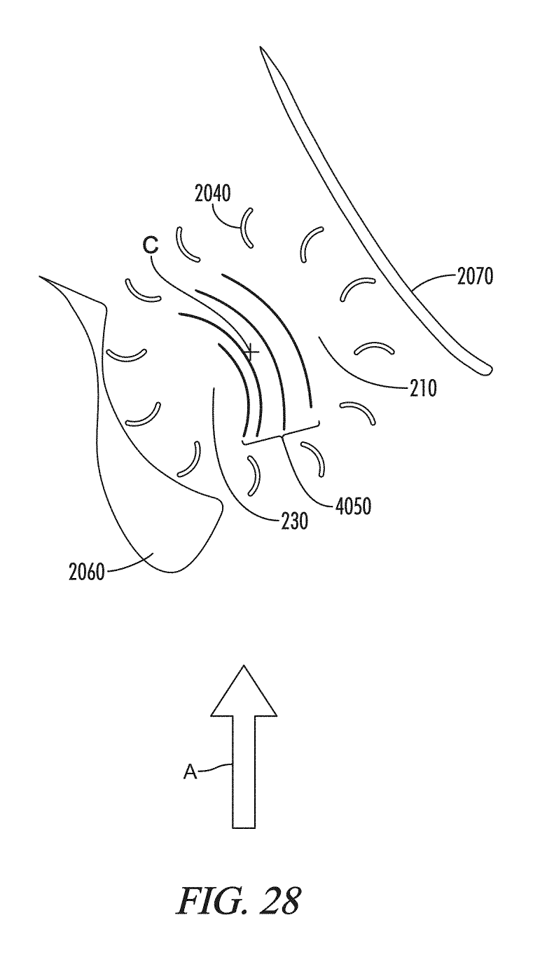

FIG. 28 illustrates a cross section of a VAWT with multiple curved plate internal diverters forming an internal diverter assembly 4050 and further comprising an external diverter assembly 2020 having a high-lift primary diverter 2060 and a low-lift secondary diverter 2070.

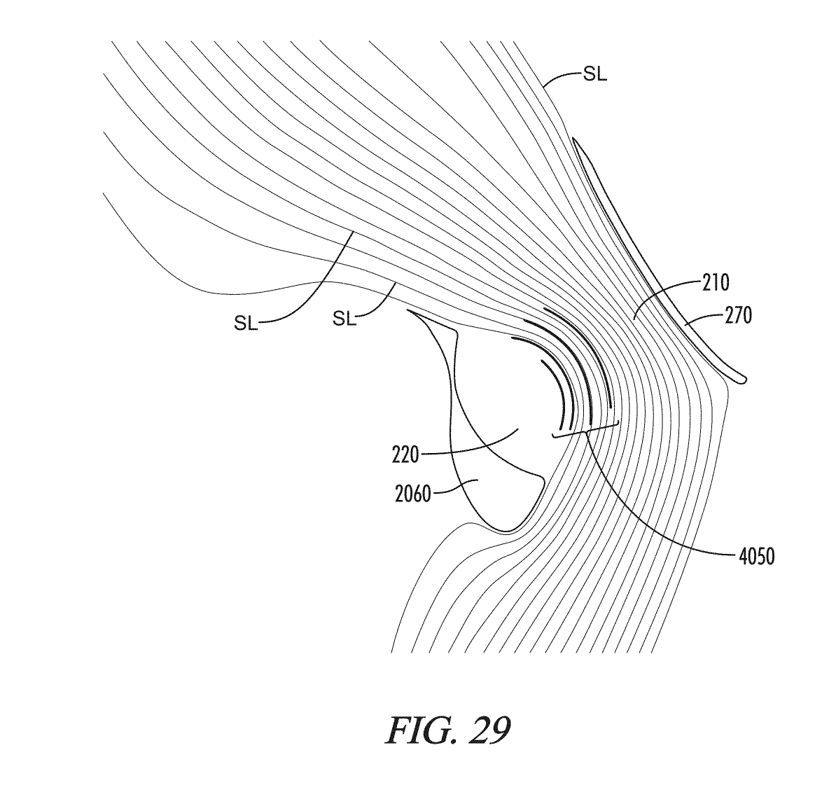

FIG. 29 illustrates a cross section of a VAWT with multiple curved plate internal diverters forming an internal diverter assembly 4050 and an external diverter assembly 2020 comprising a primary diverter 2060 and a secondary diverter 2070, with internal streamline SL flow visualization, and with the rotor assembly 2010 omitted for visualization clarity.

FIG. 30 illustrates another possible embodiment of the present disclosure in which a drag-based rotor 2010 is shielded by a double slotted 2150 high-lift diverter configuration comprising a primary diverter 2060 and flap diverters 2080, and also having an external low-lift secondary diverter 2070 and multiple curved plate internal diverters forming an internal diverter assembly 4050.

FIG. 31 illustrates another possible embodiment of the present disclosure in which a lift-based rotor is incorporated into a diverter assembly 2020 configuration otherwise similar to that of FIG. 30.

FIGS. 32-46 illustrate other possible embodiments of the present disclosure in which various possible diverter assemblies 1020, 2020 according to the present disclosure are depicted with a circle representing the outer perimeter defined by rotation of the rotor blades (not shown).

FIG. 47 shows a gap between the outer perimeter defined by rotation of the rotor blades in this embodiment drag-based rotor blades and the opposing outer surfaces of external diverters for a slotted asymmetric diverter assembly VAWT.

FIG. 48 illustrates air flow entering a gap between the outer perimeter defined by rotation of the rotor blades (in this embodiment drag-based rotor blades) and the opposing outer surfaces of external diverters for an asymmetric diverter assembly VAWT (the solid line circles indicate the inner and outer perimeters of the rotor blades as the rotor blades rotate around the vertical axis of the rotor assembly).

FIG. 49 shows a gap between the outer perimeter defined by rotation of the rotor blades and the opposing outer surfaces of external diverters for a slotted symmetric diverter assembly VAWT.

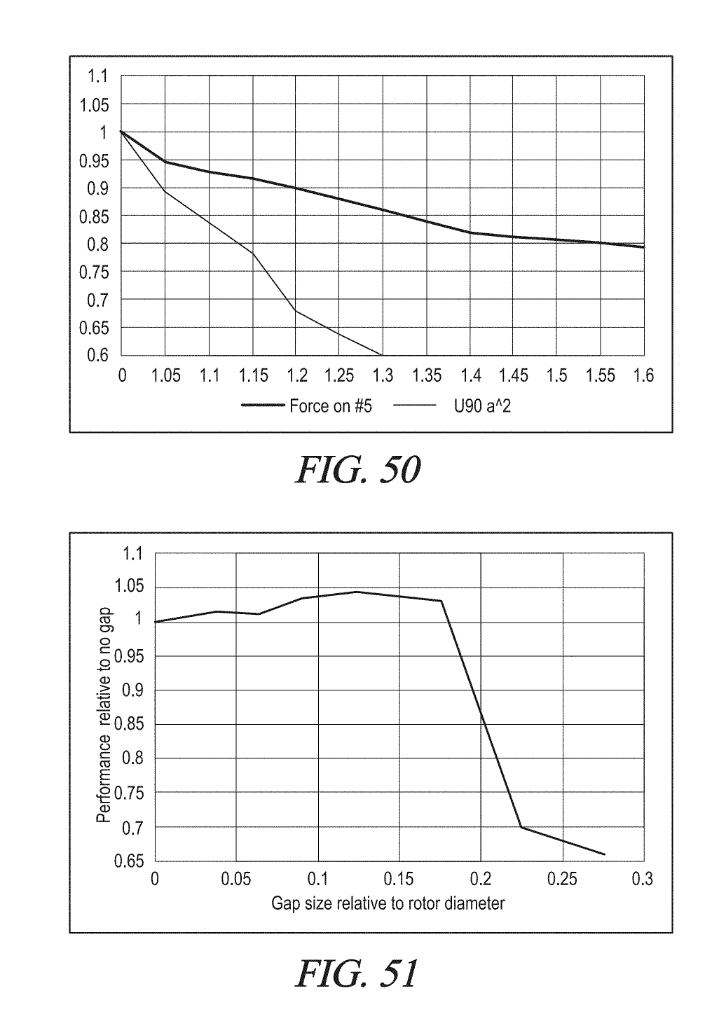

FIG. 50 is a graph showing the idealized potential losses from the gap introduction as a function of the diverter location (the gap size is the diverter location minus 1 in this graph);

FIG. 51 illustrates the overall rotor efficiency (shown as the relative power coefficient) as a function of the gap size (the gap size is normalized to the rotor diameter);

FIG. 52 illustrates a computation result of a wind power generating rotor system according to the present disclosure without a gap;

FIG. 53 illustrates a computation result of a wind power generating rotor system according to the present disclosure with a gap;

FIG. 54 depicts another embodiment of a wind power generating rotor system according to the present disclosure and FIG. 55 depicts yet another embodiment of a wind power generating rotor system according to the present disclosure. As shown, while the discussion above generally relates to two dimensional profiles for vertical axis wind turbines, plates above and below the vertical axis and diverter assemblies may also be leveraged on the top and bottom of the configurations described.

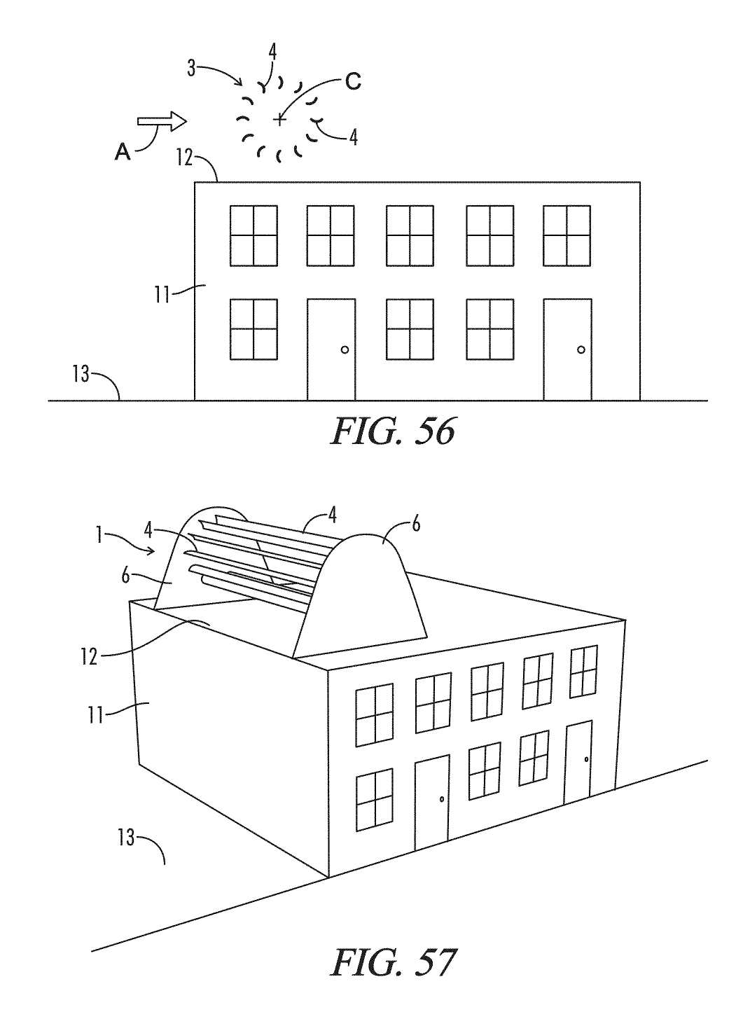

FIG. 56 illustrates a cross section of a low TSR perpendicular-axis HAWT on a rooftop. It will be understood that while the turbines shown are referred to as Horizontal Axis Wind Turbines, or HAWTs, it will be understood that the configurations shown are not to be confused with traditional horizontal axis wind turbines that may be provided with only 2-3 blades.

FIG. 57 illustrates a low TSR perpendicular-axis HAWT on a rooftop as seen in perspective.

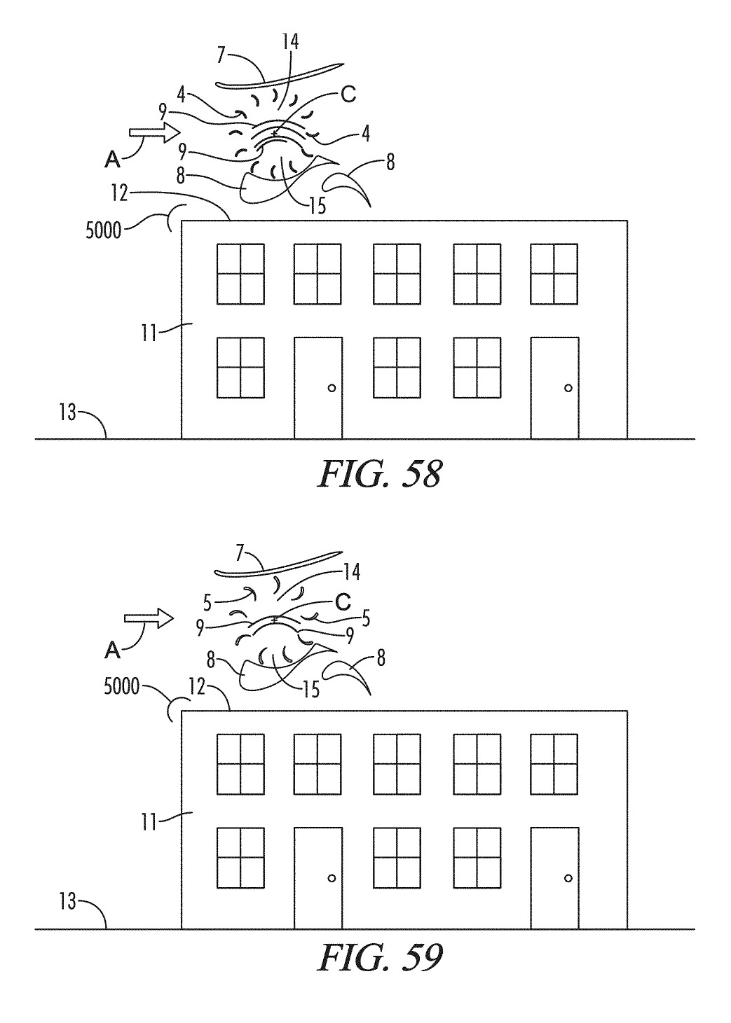

FIG. 58 illustrates a cross section of an asymmetric diverter assembly 2020 implemented in a perpendicular-axis HAWT having internal diverters on a rooftop. As shown, the rooftop configurations may be provided with a spoiler 5000 for directing airflow over a leading corner of the roof.

FIG. 59 illustrates a cross section of an asymmetric diverter assembly perpendicular-axis HAWT with airfoil-shaped rotor blades and with a different number of rotor blades and internal diverters, than the embodiment depicted in FIG. 58, on a rooftop.

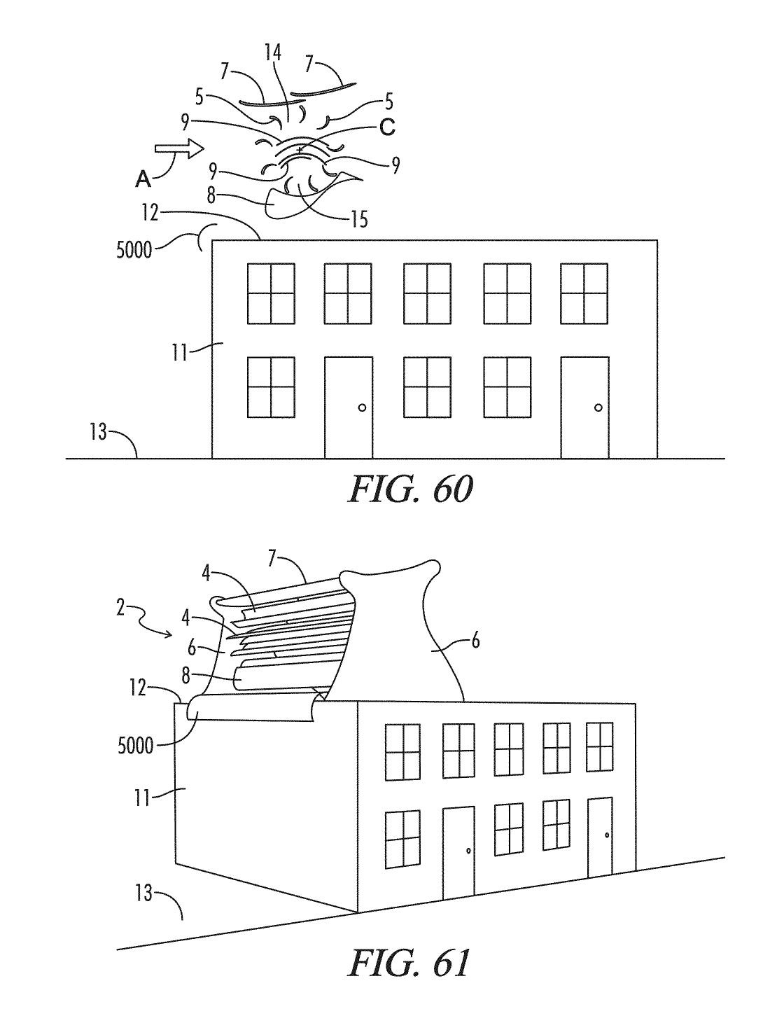

FIG. 60 illustrates a cross section of an asymmetric diverter assembly perpendicular-axis HAWT with a differently configured diverter assembly, than the embodiments depicted in FIGS. 58 and 59, on a roof-top.

FIG. 61 illustrates an asymmetric diverter assembly perpendicular-axis HAWT on a rooftop as seen in perspective.

In some embodiments, a horizontal-axis low TSR wind turbine is provided. This may be, for example, a rooftop mounted low TSR horizontal-axis wind turbine with asymmetric diverter, oriented perpendicular to the wind direction. Two features are characteristic of this embodiment:
a. The asymmetric diverter will speed up the flow on the upper part of the horizontal-axis rotor, and speed down the flow on the lower part of the rotor. The before-mentioned vertical shear of the flow over the rooftop contributes to the desired asymmetry of the flow through the rotor, and helps further enhance the aerodynamic efficiency of converting the kinetic energy contained in the wind into rotating shaft power, convertible to electric power through use of a generator.
b. The horizontal orientation of the rooftop mounted low TSR wind turbine can easily span the leading edge (or edges) of the rooftop, thereby enabling efficient “harvest” of the wind kinetic energy passing over the rooftop by simply matching the horizontal length of the low TSR wind turbine to the rooftop leading edge length. This requires only one wind turbine unit, and not a plurality of units as needed for vertical axis configurations.

The problems circumvented by this implementation helps reduce levelized energy costs for small wind rooftop applications, and make them viable economically attractive alternatives to conventional power sources.

For each of the components described here, a wide variety of geometries may be used to incorporate the devices described. For example, the various diverter geometries described above with respect to vertical axis wind turbine implementations may be used in connection with the horizontal axis implementations.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

In FIGS. 56-61, the following reference numerals apply:

### LIST OF REFERENCES

1. Normal low TSR perpendicular-axis HAWT
2. Asymmetric diverter perpendicular-axis HAWT
3. Horizontal-axis rotor (rotating around C)
4. Curved plate rotor blade (rotating around C)
5. Airfoil-shaped rotor blade (rotating around C)
6. Vertical side-endplate
7. Upper diverter part of diverter
8. Lower diverter part of diverter
9. Mid-guide-vane part of diverter
5000. Roof-edge guide-vane or spoiler
11. Building
12. Roof
13. Ground
14. High-velocity “work stroke” flow zone
15. Low-velocity “return stroke” flow zone
A. Free wind direction arrow indicator
C. Rotor rotational center indicator
   The following references have been cited in this application:
1: Widnall, S. (2009) Potential Flow Calculations of Axisymmetric Ducted Wind Turbines Massachusetts Institute of Technology, July 2009, http://hdl.handle.net/1721.1/46707
2: Watanabe, K., Takahashi, S. and Ohya, Y. (2016) Application of a Diffuser Structure to Vertical-Axis Wind Turbines, Energies 2016, 9, 406; doi:10.3390/en9060406
3: Geurts, B. M., Simao Ferreira, C., Van Bussel, G. J. W., Aerodynamic Analysis of a Vertical Axis Wind Turbine in a Diffuser, European Wind Energy Association, 3rd EWEA Conference—Torque 2010: The Science of making Torque from Wind, Heraklion, Crete, Greece, 28-30 Jun. 2010
4: Oleksandr Barannyka,*, Arash Akhgaria, Christopher O'Brien Wheelerb, Takahiro Kiwatac, Peter Oshkaia, Vortex dynamics in the near-wake of a diffuser-augmented vertical axis wind turbine, The 12th Americas Conference on Wind Engineering (12ACWE) Seattle, Wash., USA, Jun. 16-20, 2013
5: Behzad Shahizare, Nik Nazri Bin Nik Ghazali *, Wen Tong Chong, Seyed Saeed Tabatabaeikia and Nima Izadyar, Investigation of the Optimal Omni-Direction-Guide-Vane Design for Vertical Axis Wind Turbines Based on Unsteady Flow CFD Simulation, Energies 2016, 9, 146; doi:10.3390/en9030146
6: Jamieson, Peter, Innovation in wind turbine design, Wiley & Sons, 2011

What is claimed is:

1. A wind power generating rotor system for a wind turbine, comprising:
a rotor assembly having a rotor axis and a plurality of rotor blades structured and arranged for rotation around the rotor axis in response to wind passing the rotor blades thereby capturing kinetic energy from wind;
a diverter assembly adjacent to or surrounding the rotor assembly comprising a plurality of diverters arranged at one or both of inside and outside a rotation path of the rotor blades of the rotor assembly.

2. The wind power generating rotor system of claim 1, wherein the plurality of diverters of the diverter assembly are structured and arranged such that an expansion ratio of the rotor system is increased, wherein the expansion ratio is the ratio Aₑₓᵢₜ/Aᵣₒₜₒᵣ between a rotor area Aᵣₒₜₒᵣ and an exit area Aₑₓᵢₜ of the rotor system.

3. The wind power generating rotor system of claim 1, wherein the diverter assembly includes plate diverters located at respective opposing end portions of the rotor axis.

4. The wind power generating rotor system of claim 1, wherein the rotor axis is vertically oriented.

5. The wind power generating rotor system of claim 1, wherein the rotor axis is horizontally oriented.

6. The wind power generating rotor system of claim 5, wherein the horizontally oriented rotor axis is perpendicular to a direction of the wind.

7. The wind power generating rotor system of claim 1, wherein the plurality of diverters are located outside the rotation path.

8. The wind power generating rotor system of claim 7, wherein the plurality of diverters are symmetric, and wherein the plurality of diverters comprises two primary diverters opposite each other and at least one flap diverter associated with each primary diverter.

9. The wind power generating rotor system of claim 8, wherein each flap diverter is in the lee of the corresponding primary diverter.

10. The wind power generating system of claim 8, wherein the plurality of diverters further comprises at least two flap diverters associated with each of the primary diverters, wherein a gap is provided between each flap diverter and any adjacent diverters.

11. The wind power generating system of claim 8, wherein the plurality of diverters further comprises at least one slot diverter associated with a leading edge of a primary diverter, and wherein the at least one flap diverter is associated with the trailing edge of the primary diverter.

12. The wind power generating system of claim 11, wherein the plurality of diverters further comprise at least two flap diverters associated with each of the primary diverters, wherein a gap is provided between each flap diverter and any adjacent diverters, and wherein the flap diverters are associated with the trailing edge of the corresponding primary diverter, and wherein at least one slot diverter is associated with the leading edge of each primary diverter.

13. The wind power generating rotor system of claim 1, wherein at least one of the plurality of diverters is located inside the rotation path of the rotor blades.

14. The wind power generating rotor system of claim 13, wherein at least two diverters of the plurality of diverters are located outside the rotation path of the rotor blades and wherein the plurality of diverters comprises at least a primary diverter and a secondary diverter located opposite the rotor assembly from the primary diverter, the primary and secondary diverter having different profiles from each other.

15. The wind power generating rotor system of claim 14, wherein the plurality of diverters further comprise at least one flap diverter associated with the primary diverter.

16. The wind power generating rotor system of claim 14, wherein the secondary diverter comprises a flat or curved plate.

17. The wind power generating rotor system of claim 16, wherein the primary diverter has a two dimensional profile with a varying thickness.

18. The wind power generating rotor system of claim 1, wherein the plurality of diverters includes at least one primary diverter having an airfoil shape comprising a leading edge and a trailing edge.

19. The wind power generating rotor system of claim 18, wherein the primary diverter having an airfoil shape is associated with a flap diverter adjacent the trailing edge of the primary diverter.

20. The wind power generating rotor system of claim 18, wherein the plurality of diverters further comprises a plurality of flap diverters associated with the primary diverter, wherein each flap diverter has an airfoil shape, and wherein the leading edge of each flap diverter is adjacent the trailing edge of either the primary diverter or another of the flap diverters, and wherein there is a gap between each of the diverters

21. The wind power generating rotor system of claim 18, wherein the primary diverter has an airfoil shape that abuts the rotation path, and wherein the rotation path passes through and disrupts a portion of the airfoil shape.

22. The wind power generating rotor system of claim 1, wherein the plurality of diverters includes at least one diverter having at least two generally flat elements in a stacked configuration to form the diverter.

23. The wind power generating rotor system of claim 1, wherein the plurality of rotor blades are arranged in a lift based configuration, wherein the rotor blades are substantially tangential to the perimeter of rotation path of the rotor blades.

24. The wind power generating system of claim 23, wherein the diverter assembly comprises two primary diverters substantially symmetrically arranged opposite the rotor assembly from each other, and at least one flap diverter is associated with each of the primary diverters.

25. The wind power generating rotor system of claim 1, wherein the plurality of rotor blades are arranged in a drag based configuration, wherein the rotor blades are substantially perpendicular to the perimeter of the rotation path of the rotor blades.

26. The wind power generating rotor system of claim 1, wherein a predetermined gap is provided between the rotation path and at least one diverter located outside the perimeter.

27. The wind power generating rotor system of claim 26, wherein the predetermined gap is from 3.5% to 25% of a diameter of the perimeter of the rotation path.

28. The wind power generating rotor system of claim 27, wherein the predetermined gap is about 15% of the diameter of the rotation path.

29. The wind power generating rotor system of claim 26, wherein the predetermined gap is arranged for bypass flow of wind passing the rotor blades thereby stabilizing wind flow.

30. The wind power generating rotor system of claim 26, wherein the plurality of diverters include a primary diverter and a secondary diverter, and wherein the predetermined gap is between the secondary diverter and the rotation path.

31. The wind power generating rotor system of claim 26, wherein the plurality of diverters include two primary diverters arranged symmetrically opposite the rotor assembly from each other, and wherein the predetermined gap is between each of the primary diverters and the corresponding side of the rotation path.

32. The wind power generating rotor system of claim 26, wherein the predetermined wind gap fluctuates during use of the system to actively balance the bypass flow rate.
